(19) United States
(12) Patent Application Publication
(10) Pub. No.: US 2025/0136762 A1
(43) Pub. Date: May 1, 2025

(54) HOST GROUP-CONTAINING POLYMERIZABLE MONOMER, POLYMER MATERIAL, AND METHOD FOR MANUFACTURING SAME

(71) Applicants: OSAKA UNIVERSITY, Suita-shi (JP); YUSHIRO CHEMICAL INDUSTRY CO., LTD., Tokyo (JP)

(72) Inventors: Yoshinori Takashima, Suita-shi (JP); Akira Harada, Suita-shi (JP); Motofumi Osaki, Suita-shi (JP); Junsu Park, Suita-shi (JP); Ryohei Ikura, Suita-shi (JP); Changming Jin, Suita-shi (JP); Hidenori Shirakawa, Koza-gun (JP); Yujiro Kitamura, Koza-gun (JP)

(73) Assignees: OSAKA UNIVERSITY, Suita-shi (JP); YUSHIRO CHEMICAL INDUSTRY CO., LTD., Tokyo (JP)

(21) Appl. No.: 18/684,206

(22) PCT Filed: Aug. 19, 2022
(86) PCT No.: PCT/JP2022/031384

§ 371 Date: Feb. 16, 2024

(30) Foreign Application Priority Data
Aug. 23, 2021 (JP) 2021-135760

(51) Int. Cl. C08G 75/02

(52) U.S. Cl. CPC C08G 75/02

(57) ABSTRACT

The present invention provides a host group-containing polymerizable monomer that can be used as a raw material for producing a macromolecular material having excellent toughness and strength, and a method for producing the same, as well as a macromolecular material produced by using the host group-containing polymerizable monomer, and a method for producing the same. The present invention provides a host group-containing polymerizable monomer, the host group-containing polymerizable monomer having a sulfide group, the host group being a monovalent group formed by removing one hydrogen atom or hydroxy group from a cyclodextrin derivative, and the cyclodextrin derivative having a structure formed such that a hydrogen atom of at least one hydroxy group contained in a cyclodextrin is replaced with at least one group selected from the group consisting of a hydrocarbon group, an acyl group, and —CONHR wherein R represents a methyl group or an ethyl group.

### TECHNICAL FIELD

The present invention relates to a host group-containing polymerizable monomer, a macromolecular material, and methods for producing them.

### BACKGROUND ART

Supramolecular materials that are highly functionalized in various aspects have been actively developed by sophisticatedly using non-covalent-bond interaction, such as host-guest interaction. For example, PTL 1 discloses a self-repairing material that uses the reversibility of host-guest interaction. Even if the entire material is cut, this self-repairing material can be recovered to the original material strength by bringing the cut surfaces into contact with each other again, and is highly anticipated as a novel functional macromolecular material.

### CITATION LIST

### Patent Literature

PTL 1: WO2015/030079

### SUMMARY OF INVENTION

### Technical Problem

Recently, adding various functionalities to the macromolecular materials themselves has been required. For example, there is a strong need for the development of macromolecular materials with further improved mechanical properties, such as toughness and strength.

In this respect, for example, conventional research on macromolecular materials using host-guest interaction has mainly been carried out in radical polymerization reactions. Because there were restrictions on changing the composition of polymers contained in macromolecular materials, it was considered difficult to significantly improve mechanical properties.

Polyurethane (PU) is conventionally used as a macromolecular material. Polyurethane, also known as urethane rubber, is a plastic material that is soft like rubber and has excellent tensile strength, elasticity, and oil resistance. However, polyurethane is a soft material, as described above, and is thus less hard than glass or metal, causing problems with its surface being susceptible to minute cuts, such as abrasions, and poor toughness. In addition, due to these problems, there is a problem that minute scratches accumulate over time to cause deterioration, resulting in a decrease in strength.

The present inventors focused on the fact that stronger materials can be obtained by introducing reversible/movable crosslinking by host-guest interaction mentioned above into macromolecular materials, such as polyurethane. Upon further careful consideration, the present inventors succeeded in synthesizing a host group-containing polymerizable monomer having acetylated cyclodextrin (CD) as a host group, and also succeeded in forming reversible/movable crosslinking in macromolecular materials, such as polyurethane, by performing a condensation polymerization reaction using this monomer. The present inventors then arrived at the present invention.

The present invention was made in view of these circumstances in the art. An object of the invention is to provide a host group-containing polymerizable monomer that can be used as a raw material for producing a macromolecular material having excellent toughness and strength, and a method for producing the same, as well as a macromolecular material produced by using the host group-containing polymerizable monomer, and a method for producing the same.

### Solution to Problem

The present inventors conducted extensive research to achieve the object, and found that the object can be achieved by introducing a host group having a specific structure into a polymerizable monomer. The present inventors then completed the present invention.

Specifically, the present invention includes the inventions described in the following items.

1. A host group-containing polymerizable monomer,
the host group-containing polymerizable monomer having a sulfide group,
the host group being a monovalent group formed by removing one hydrogen atom or hydroxy group from a cyclodextrin derivative, and
the cyclodextrin derivative having a structure formed such that a hydrogen atom of at least one hydroxy group contained in a cyclodextrin is replaced with at least one group selected from the group consisting of a hydrocarbon group, an acyl group, and —CONHR wherein R represents a methyl group or an ethyl group.

2. The host group-containing polymerizable monomer according to Item 1, wherein the acyl group is an acetyl group.

3. The host group-containing polymerizable monomer according to Item 1 or 2, wherein the hydrocarbon group has 1 to 4 carbon atoms.

4. The host group-containing polymerizable monomer according to any one of Items 1 to 3, which is represented by the following formula (h1):

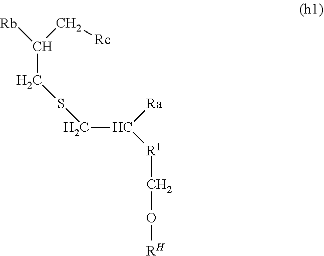

wherein in formula (h1), Ra represents a hydrogen atom or a methyl group, Rb and Rc represents a hydroxyl group or an isocyanate group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group.

5. The host group-containing polymerizable monomer according to any one of Items 1 to 3, which is represented by the following formula (h2):

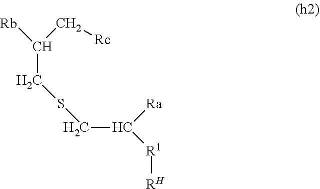

wherein in formula (h2), Ra represents a hydrogen atom or a methyl group, Rb and Rc represents a hydroxyl group or an isocyanate group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group.

6. A method for producing a host group-containing polymerizable monomer, comprising reacting a host group-containing polymerizable monomer and a thiol group-containing compound having a thiol group and two functional groups.

7. The method according to Item 6, wherein the reaction is a thiol-ene reaction.

8. A macromolecular material comprising a polymer of the host group-containing polymerizable monomer according to any one of Items 1 to 5.

9. A method for producing a macromolecular material, comprising subjecting a polymerizable monomer mixture containing the host group-containing polymerizable monomer according to any one of Items 1 to 5 to a polymerization reaction to obtain a polymer.

### Advantageous Effects of Invention

The host group-containing polymerizable monomer according to the present invention can be used as a raw material for producing a macromolecular material, and the resulting macromolecular material particularly has excellent toughness and strength.

The method for producing a host group-containing polymerizable monomer according to the present invention is suitable as a method for producing the host group-containing polymerizable monomer described above, and can produce the host group-containing polymerizable monomer with a simple process.

The macromolecular material according to the present invention contains a polymer produced by using the host group-containing polymerizable monomer, and thus has excellent toughness and strength.

The method for producing a macromolecular material according to the present invention is suitable as a method for producing the macromolecular material described above, and can produce the macromolecular material with a simple process.

### BRIEF DESCRIPTION OF DRAWINGS

FIG. 1 schematically shows the macromolecular material of the present invention. FIG. 1 shows a macromolecular material in which the host group is a monovalent group formed by removing one hydrogen atom or hydroxy group from a β-cyclodextrin derivative.

FIG. 2 schematically shows the macromolecular material of the present invention. FIG. 2 shows a macromolecular material in which the host group is a monovalent group formed by removing one hydrogen atom or hydroxy group from a γ-cyclodextrin derivative.

FIG. 3 shows the production scheme of PAcβCDAAmMe-S-diOH of Production Example 1.

FIG. 4 shows the production scheme of βMeₓPU of Example 1-1 to Example 1-5.

FIG. 5 shows the structural formula of the polyurethane resin (PU) prepared in Comparative Example 1.

FIG. 6 shows the production scheme of PAcγCDAAmMe-S-diOH of Production Example 2.

FIG. 7 shows the production scheme of γMeₓPU of Example 2-1 to Example 2-5.

FIG. 8 shows the stress-strain curves of Example 1-1 to Example 1-3, Example 1-5, and Comparative Example 1.

FIG. 9 shows the relationship between Young's modulus and fracture energy in Example 1-1 to Example 1-3, Example 1-5, and Comparative Example 1.

FIG. 10 shows the stress-strain curves of Example 2-1 to Example 2-5 and Comparative Example 1.

FIG. 11 shows the relationship between Young's modulus and fracture energy in Example 2-1 to Example 2-5 and Comparative Example 1.

FIG. 12 shows the results of a tensile test for determining strain in a stress relaxation test.

FIG. 13 shows the measurement results of the stress relaxation test.

FIG. 14 shows the results of the macromolecular material formed from the polymer obtained in Example 2-1 photographed with a microscope and a laser microscope.

FIG. 15 shows the results of the macromolecular material formed from the polymer obtained in Example 2-2 photographed with a microscope and a laser microscope.

FIG. 16 shows the results of the macromolecular material formed from the polymer obtained in Example 2-3 photographed with a microscope and a laser microscope.

FIG. 17 shows the results of the macromolecular material formed from the polymer obtained in Comparative Example 1 photographed with a microscope and a laser microscope.

FIG. 18 shows the relationship between scratch area and time in the macromolecular materials formed from the polymers obtained in Example 2-1 to Example 2-3 and Comparative Example 1.

FIG. 19 shows the relationship between scratch healing ratio and time in the macromolecular materials formed from the polymers obtained in Example 2-1 to Example 2-3 and Comparative Example 1.

FIG. 20 schematically shows the macromolecular material of the present invention. FIG. 20 shows a macromolecular material in which the host group is a monovalent group formed by removing one hydrogen atom or hydroxy group from a β-cyclodextrin derivative.

FIG. 21 shows the production scheme of PAcβCDAAm-S-diOH of Production Example 3.

FIG. 22 shows the production scheme of βₓPU of Example 3-1.

FIG. 23 shows the stress-strain curves of Example 3-1 and Comparative Example 1.

FIG. 24 shows the relationship between Young's modulus and fracture energy in Example 3-1 and Comparative Example 1.

FIG. 25 shows the production scheme of the SCP-crosslinking material (γMeₓPU⊃PDMAA) of Example 4-1.

FIG. 26 shows the production scheme of the SCP-crosslinking material (γMeₓPU⊃P (DMAA-MA)) of Example 4-2.

FIG. 27 shows the production scheme of the macromolecular mixed material (PU/PDMAA) of Comparative Example 4-1.

FIG. 28 shows the stress-strain curves of Example 4-2 and Comparative Example 4-1.

FIG. 29 shows the relationship between Young's modulus and fracture energy in Example 4-2 and Comparative Example 4-1.

FIG. 30 is a conceptual diagram showing a production method to produce a macromolecular material having a SCP structure from a movable crosslinked structure.

### DESCRIPTION OF EMBODIMENTS

Below, embodiments of the present invention are described in detail. The terms “comprise,” “contain,” and “include” in the present specification include the concepts of “comprise,” “contain,” “include,” “consist essentially of,” and “consist of.”

### 1. Host Group-Containing Polymerizable Monomer

In the host group-containing polymerizable monomer of the present invention, the host group is a monovalent group formed by removing one hydrogen atom or hydroxy group from a cyclodextrin derivative. Further, the cyclodextrin derivative has a structure formed such that a hydrogen atom of at least one hydroxy group contained in a cyclodextrin is replaced with at least one group selected from the group consisting of a hydrocarbon group, an acyl group, and —CONHR wherein R represents a methyl group or an ethyl group. In the cyclodextrin derivative, at least one hydroxyl group contained in a cyclodextrin may be replaced with a hydrocarbon group alone or an acyl group alone.

The host group-containing polymerizable monomer of the present invention can serve as a raw material for obtaining a polymer contained in a macromolecular material. The polymer obtained by using the host group-containing polymerizable monomer can have, for example, a structure in which molecules are crosslinked with each other by reversible host-guest interaction. Alternatively, the polymer obtained by using the host group-containing polymerizable monomer can be, for example, a movable crosslinked polymer described later. As described later, the movable crosslinked polymer is, for example, a polymer having a structure formed such that the main chain of another polymer penetrates the ring of the host group (cyclic molecule with a cyclodextrin structure) of the polymer side chain.

The cyclodextrin derivative is preferably at least one member selected from the group consisting of α-cyclodextrin derivatives, β-cyclodextrin derivatives, and γ-cyclodextrin derivatives. The cyclodextrin derivative as used in the present specification refers to a molecule with a structure formed such that a cyclodextrin molecule is substituted with a different organic group. Just to note, “cyclodextrin” in the present specification refers to at least one member selected from the group consisting of α-cyclodextrin, β-cyclodextrin, and γ-cyclodextrin.

As described above, the host group is a monovalent group formed by removing one hydrogen atom or hydroxy group from a cyclodextrin derivative. The removed hydrogen atom or hydroxy group may be of any site of the cyclodextrin derivative. From the standpoint of ease of forming a host group, the host group is preferably a monovalent group formed by removing one hydroxy group from a cyclodextrin derivative.

As described above, the cyclodextrin derivative for forming a host group has a structure formed such that at least one hydroxy group contained in a cyclodextrin is replaced with at least one group selected from the group consisting of a hydrocarbon group, an acyl group, and —CONHR wherein R represents a methyl group or an ethyl group. Due to this structure, the host group-containing polymerizable monomer of the present invention can show high affinity, for example, for both hydrophilic polymerizable monomers and hydrophobic polymerizable monomers, and the host group-containing polymerizable monomer can be copolymerized with various polymerizable monomers. In the present specification, “at least one group selected from the group consisting of a hydrocarbon group, an acyl group, and —CONHR wherein R represents a methyl group or an ethyl group” may be referred to as “a hydrocarbon group etc.” for convenience.

Since the host group-containing polymerizable monomer of the present invention particularly shows high solubility in hydrophobic polymerizable monomers, copolymerization of a host group-containing polymerizable monomer and a hydrophobic polymerizable monomer, which has been considered to be difficult, is now possible in a wide range of composition ratios, making it possible to increase the degree of freedom in the design of the desired macromolecular material.

When the total number of hydroxy groups in a single molecule of a cyclodextrin is N, N of α-cyclodextrin is 18, N of β-cyclodextrin is 21, and N of γ-cyclodextrin is 24.

If the host group is a monovalent group formed by removing one “hydroxy group” from a cyclodextrin derivative, the maximum number of hydroxy groups whose hydrogens can be replaced with a hydrocarbon group etc. is N−1 per molecule of the cyclodextrin derivative. If the host group is a monovalent group formed by removing one “hydrogen atom” from a cyclodextrin derivative, the maximum number of hydroxy groups whose hydrogens can be replaced with a hydrocarbon group etc., is N per molecule of the cyclodextrin derivative.

The host group preferably has a structure such that the hydrogen atoms of at least 70% of the total number of hydroxy groups per molecule of the cyclodextrin derivative are replaced with a hydrocarbon group etc. In this case, the host group-containing polymerizable monomer can show higher affinity for hydrophobic polymerizable monomers. The host group more preferably has a structure such that the hydrogen atoms of at least 80% of the total number of hydroxy groups per molecule of the cyclodextrin derivative are replaced with a hydrocarbon group etc.; and particularly preferably has a structure such that the hydrogen atoms of at least 90% of the total number of hydroxy groups per molecule of the cyclodextrin derivative are replaced with a hydrocarbon group etc.

The host group preferably has a structure such that the hydrogen atoms of at least 11 hydroxy groups out of the total number of hydroxy groups per molecule of α-cyclodextrin derivative are replaced with a hydrocarbon group etc. In this case, the host group-containing polymerizable monomer can show higher affinity for hydrophobic polymerizable monomers. The host group more preferably has a structure such that the hydrogen atoms of at least 12 hydroxy groups out of the total number of hydroxy groups per molecule of α-cyclodextrin derivative are replaced with a hydrocarbon group etc.; even more preferably has a structure such that the hydrogen atoms of at least 15 hydroxy groups out of the total number of hydroxy groups per molecule of α-cyclodextrin derivative are replaced with a hydrocarbon group etc.; and particularly preferably has a structure such that the hydrogen atoms of 17 hydroxy groups out of the total number of hydroxy groups per molecule of α-cyclodextrin derivative are replaced with a hydrocarbon group etc.

The host group preferably has a structure such that the hydrogen atoms of at least 13 hydroxy groups out of the total number of hydroxy groups per molecule of β-cyclodextrin derivative are replaced with a hydrocarbon group etc. In this case, the host group-containing polymerizable monomer can show higher affinity for hydrophobic polymerizable monomers. The host group more preferably has a structure such that the hydrogen atoms of at least 17 hydroxy groups out of the total number of hydroxy groups per molecule of β-cyclodextrin derivative are replaced with a hydrocarbon group etc.; and particularly preferably has a structure such that the hydrogen atoms of at least 19 hydroxy groups out of the total number of hydroxy groups per molecule of β-cyclodextrin derivative are replaced with a hydrocarbon group etc.

The host group preferably has a structure such that the hydrogen atoms of at least 17 hydroxy groups out of the total number of hydroxy groups per molecule of γ-cyclodextrin derivative are replaced with a hydrocarbon group etc. In this case, the host group-containing polymerizable monomer can show higher affinity for hydrophobic polymerizable monomers. The host group more preferably has a structure such that the hydrogen atoms of at least 19 hydroxy groups out of the total number of hydroxy groups per molecule of γ-cyclodextrin derivative are replaced with a hydrocarbon group etc.; and particularly preferably has a structure such that the hydrogen atoms of at least 22 hydroxy groups out of the total number of hydroxy groups per molecule of γ-cyclodextrin derivative are replaced with a hydrocarbon group etc.

The type of hydrocarbon group is not particularly limited. Examples of the hydrocarbon group include an alkyl group, an alkenyl group, and an alkynyl group.

The number of carbon atoms in the hydrocarbon group is not particularly limited. The number of carbon atoms in the hydrocarbon group is preferably 1 to 4 because the host group-containing polymerizable monomer shows a higher affinity for both hydrophilic and hydrophobic polymerizable monomers, and host-guest interaction can be easily formed.

Specific examples of hydrocarbon groups having 1 to 4 carbon atoms include a methyl group, an ethyl group, a propyl group, and a butyl group. When the hydrocarbon group is a propyl group or a butyl group, the hydrocarbon group may be linear or branched.

The hydrocarbon group may be substituted, as long as the effects of the present invention are not impaired.

Examples of the acyl group include an acetyl group, a propionyl group, and a formyl group. The acyl group may be further substituted. The acyl group is preferably an acetyl group because the host group-containing polymerizable monomer shows a higher affinity for both hydrophilic and hydrophobic polymerizable monomers, host-guest interaction can be easily formed, and a macromolecular material having excellent toughness and strength can be easily obtained.

—CONHR wherein R represents a methyl group or an ethyl group is a methyl carbamate group or an ethyl carbamate group. —CONHR is preferably an ethyl carbamate group because the host group-containing polymerizable monomer shows a higher affinity for both hydrophilic and hydrophobic polymerizable monomers, and host-guest interaction can be easily formed.

The structure of the host group-containing polymerizable monomer of the present invention is not particularly limited as long as it is a polymerizable compound having the host group and a sulfide group. The term “polymerizable” as used in the present specification refers to, for example, having properties of various conventionally known polymerizations, such as radical polymerization, ionic polymerization, polycondensation (condensation polymerization), addition condensation, living polymerization, and living radical polymerization.

The host group-containing polymerizable monomer is preferably a compound capable of radical polymerization or polycondensation (condensation polymerization), from the standpoint of ease of synthesis and ease of obtaining a macromolecular material having excellent toughness and strength.

The type of host group-containing polymerizable monomer is not particularly limited as long as it has a host group and a polymerizable functional group. Specific examples of polymerizable functional groups include an alkenyl group, a vinyl group, and the like, as well as —OH, —SH, —NH₂, —COOH, —SO₃H, —PO₄H, an isocyanate group, an epoxy group (glycidyl group), and the like. Such a polymerizable functional group can be introduced into a cyclodextrin derivative in such a manner that in the cyclodextrin derivative, a hydrogen atom of at least one hydroxy group contained in a cyclodextrin is replaced. As a result, a host group-containing polymerizable monomer having a polymerizable functional group is formed.

The host group-containing polymerizable monomer of the present invention has a sulfide group. The sulfide group is not particularly limited, and is, for example, a bifunctional group obtained by removal of one hydrogen atom from each of the two alkyl groups bonded to the sulfur element of sulfide.

Examples of the sulfide group include a group represented by the formula —R′—S—R″—.

In the above formula, R′ and R″ are the same or different and each represent a C₁ or C₂ alkyl group.

Examples of the sulfide include dimethyl sulfide, diethyl sulfide, dibutyl sulfide, ethyl methyl sulfide, and the like.

Specific examples of the host group-containing polymerizable monomer of the present invention include a compound represented by the following formula (h1):

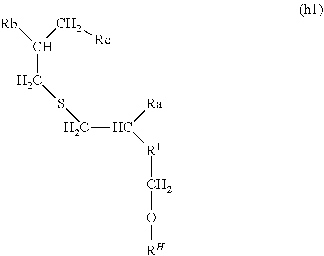

In formula (h1), Ra represents a hydrogen atom or a methyl group, Rb and Rc represents a hydroxyl group or an isocyanate group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group.

Specific examples of the host group-containing polymerizable monomer of the present invention also include a compound represented by the following formula (h2):

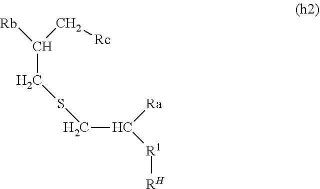

In formula (h2), Ra represents a hydrogen atom or a methyl group, Rb and Rc represents a hydroxyl group or an isocyanate group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group.

Host group R^{H} in the host group-containing polymerizable monomers represented by formulas (h1) and (h2) is an example of a monovalent group formed by removing one hydroxy group from a cyclodextrin derivative.

Moreover, the host group-containing polymerizable monomer may be one of the compounds represented by formulas (h1) and (h2) alone, or may contain two or more of them. In this case, Ra in formulas (h1) and (h2) are the same or different in some cases. Similarly, R^{H} in formulas (h1) and (h2) are the same or different in some cases, and R¹ in formulas (h1) and (h2) are the same or different in some cases.

The substituents defined in formulas (h1) and (h2) are not particularly limited. Examples of the substituents include a C₁₋₂₀ alkyl group, a C₂₋₂₀ alkynyl group, a C₂₋₂₀ alkynyl group, a halogen atom, a carboxyl group, a carbonyl group, a sulfonyl group, a sulfone group, and a cyano group.

### 2. Method for Producing Host Group-Containing Polymerizable Monomer

The method for producing the host group-containing polymerizable monomer is not particularly limited. For example, the host group-containing polymerizable monomer can be produced by a production method comprising reacting a host group-containing vinyl monomer and a thiol group-containing compound having a thiol group and two functional groups. Such a production method is also included in the present invention.

The thiol group-containing compound is not particularly limited as long as it has a thiol group and two functional groups. Examples include a compound represented by the following formula (t1):

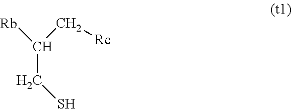

In the above formula (t1), Rb and Rc represent hydroxyl groups or isocyanate groups. Specifically, these are respectively the same as Rb and Rc in the host group-containing polymerizable monomers represented by the above formulas (h1) and (h2).

The host group-containing vinyl monomer is not particularly limited as long as it has the host group and a vinyl group. Examples include a compound represented by the following formula (v1):

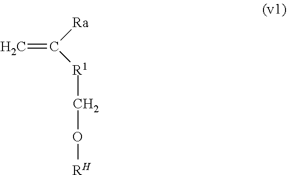

or a compound represented by the following formula (v2):

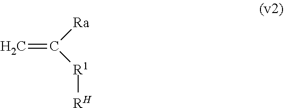

In the above formulas (v1) and (v2), Ra represents a hydrogen atom or a methyl group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group. Specifically, these are respectively the same as Ra, R^{H}, and R¹ in the host group-containing polymerizable monomers represented by the above formulas (h1) and (h2).

In the above step, the method for reacting a host group-containing vinyl monomer and a thiol group-containing compound having a thiol group and two functional groups is not particularly limited, and they may be reacted by a conventionally known method. Examples of such methods include a reaction method using a thiol-ene reaction, a reaction method using a conjugate addition reaction, and the like; and preferred is a reaction method using a thiol-ene reaction. The reaction method using a thiol-ene reaction can suppress the generation of by-products and can efficiently and easily produce the host group-containing polymerizable monomer of the present invention.

Examples of the thiol-ene reaction include a thiol-ene reaction that reacts a double bond with thiol by photoexcitation using a photoinitiator; a thiol-ene reaction that reacts a double bond with thiol using a radical initiator other than photoinitiators, such as a thermal initiator or a redox initiator; and the like.

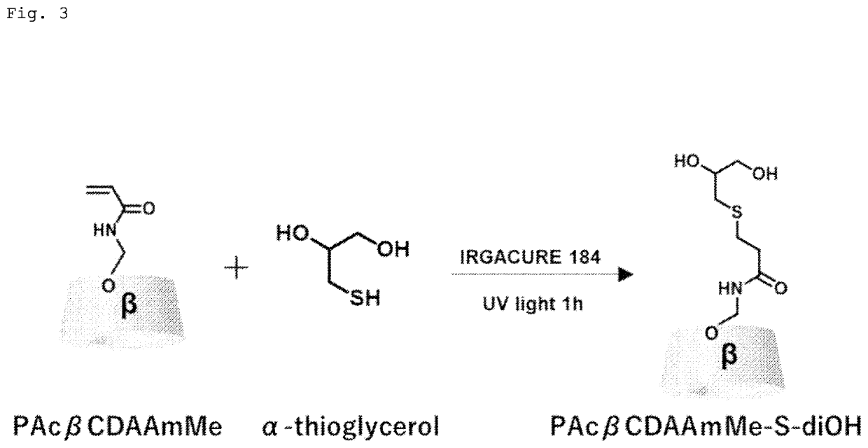

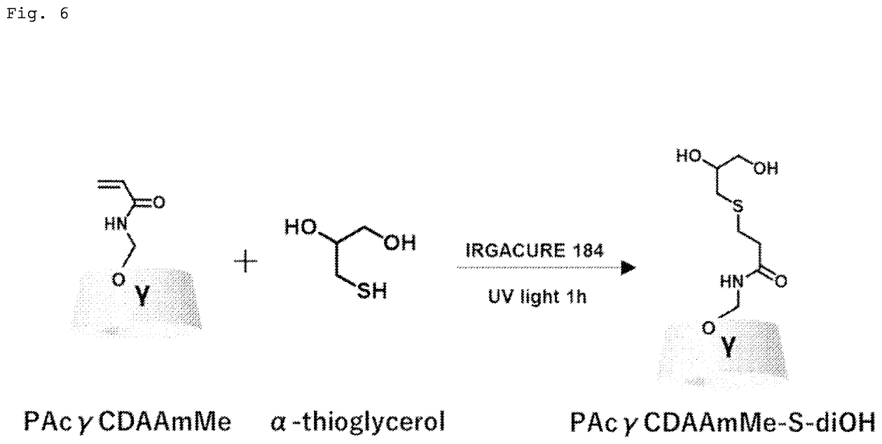

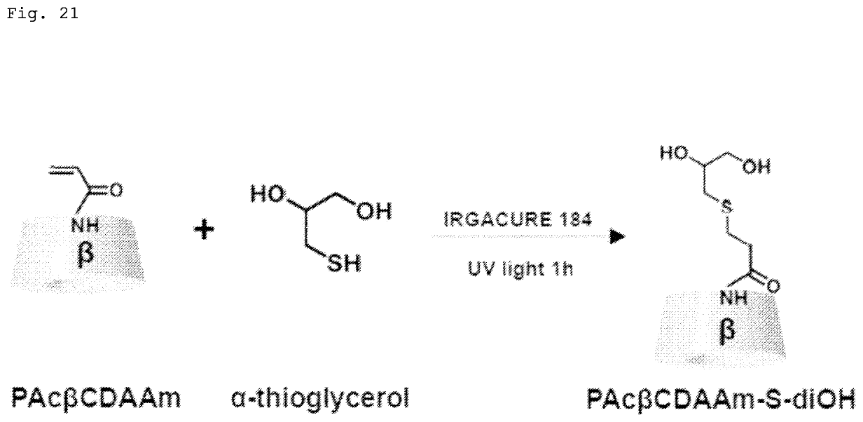

Specific examples of the method for producing the host group-containing polymerizable monomer of the present invention by a thiol-ene reaction include the production methods shown in FIGS. 3, 6, and 21. FIG. 3 shows a production method when the host group is a monovalent group formed by removing one hydrogen atom or hydroxy group from a β-cyclodextrin derivative (production scheme of PAcβCDAAmMe-S-diOH), and FIG. 6 shows a production method when the host group is a monovalent group formed by removing one hydrogen atom or hydroxy group from a γ-cyclodextrin derivative (production scheme of PAcγCDAAmMe-S-diOH). FIG. 21 shows a production method when the host group is a monovalent group formed by removing one hydrogen atom or hydroxy group from a β-cyclodextrin derivative (production scheme of PAcβCDAAm-S-diOH).

In the thiol-ene reaction, as shown in FIGS. 3, 6, and 21, it is preferable to mix a host group-containing vinyl monomer and a thiol group-containing compound having a thiol group and two functional groups, further add a photopolymerization initiator to prepare a photopolymerizable composition, and irradiate the photopolymerizable composition with ultraviolet rays to perform reaction.

The photopolymerization initiator is not particularly limited as long as it can react the host group-containing vinyl monomer and the thiol group-containing compound having a thiol group and two functional groups. As the photopolymerization initiator, any of various photopolymerization initiators, such as molecular cleavage type and hydrogen abstraction type, can be used.

Specific examples of molecular cleavage type photopolymerization initiators include 1-hydroxycyclohexyl phenyl ketone, benzoyl ethyl ether, benzyl dimethyl ketal, 2-hydroxy-2-methyl-1-phenyl-propan-1-one, 1-(4-isopropylphenyl)-2-hydroxy-2-methylpropan-1-one, 2,2-dimethoxy-1,2-diphenylethan-1-one, 2-methyl-4′-(methylthio)-2-morpholinopropiophenone, and the like.

Specific examples of hydrogen abstraction type photopolymerization initiators include benzophenone, 4-phenylbenzophenone, isophthalophenone, 4-benzoyl-4′-methyl-diphenyl sulfide, and the like.

These photopolymerization initiators may be used singly or as a mixture of two or more.

The content of the photopolymerization initiator in the photopolymerizable composition is preferably 0.03 to 0.20 mass %, more preferably 0.05 to 0.15 mass %, even more preferably 0.08 to 0.12 mass %, and particularly preferably 0.09 to 0.11 mass %, based on 100 mass % of the photopolymerizable composition.

The content of the host group-containing vinyl monomer in the photopolymerizable composition is preferably 88 to 99.5 mass %, more preferably 90 to 99 mass %, even more preferably 93 to 97 mass %, and particularly preferably 94 to 96 mass %, based on 100 mass % of the photopolymerizable composition.

The content of the thiol group-containing compound having a thiol group and two functional groups in the photopolymerizable composition is preferably 0.5 to 12 mass %, more preferably 1 to 10 mass %, even more preferably 3 to 7 mass %, and particularly preferably 4 to 6 mass %, based on 100 mass % of the photopolymerizable composition.

In the photopolymerizable composition, the thiol-ene reaction progresses when the molar ratio of the host group-containing vinyl monomer and the thiol group-containing compound having a thiol group and two functional groups is 1:1; however, the molar ratio may be about 1:5 to 1:10.

The conditions for UV irradiation of the photopolymerizable composition in the above step are not particularly limited, and it is preferable to irradiate the photopolymerizable composition with ultraviolet rays of about 6.5 to 7.5 mW/cm², and more preferably about 7.0 to 7.2 mW/cm². The UV irradiation time is also not particularly limited, and may be preferably about 50 to 80 minutes, and more preferably about 60 to 70 minutes.

The temperature of the photopolymerizable composition in the above step is not particularly limited, and is preferably 20 to 30° C., and more preferably 24 to 26° C.

### Guest Molecule

In a macromolecular material described later, at least one guest molecule penetrates the host group contained in the unit derived from the host group-containing polymerizable monomer of the present invention to from a complex, and the guest molecule can be bonded by a hydrogen bond etc. to the polymer chain that forms the macromolecular material. More specifically, the guest molecule can be bonded by a hydrogen bond etc. to the main chain or side chain of the polymer chain that forms the macromolecular material.

Further, the host group-containing polymerizable monomer of the present invention becomes an inclusion compound by being held in a state in which the guest molecule penetrates the host group. This inclusion compound is formed in such a manner that host-guest interaction occurs between the host group and the guest molecule. When such an inclusion compound is formed, the inclusion compound can dissolve in a solvent to form a more homogeneous solution, which facilitates the polymerization reaction and the formation of host-guest interaction in the resulting polymer. As a result, the toughness and strength of the resulting macromolecular material are likely to be improved.

The guest molecule is not particularly limited as long as it can form an inclusion complex together with the host group. For example, a polyalkylene oxide can be suitably used. Other usable examples of the guest molecule include compounds having one or two amino groups, compounds having one or two hydroxyl groups, compounds having one or two carboxy groups, compounds having one or two epoxy groups, compounds having one or two isocyanate groups, compounds having one or two thiol groups, and compounds having one or two carboxylic acid chlorides.

The polyalkylene oxide is not particularly limited, and known polyalkylene oxides can be used. A compound represented by the following formula (po) can be used as such an alkylene oxide.

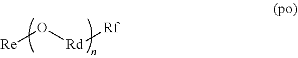

In the above formula (po), Rd represents a C₁₋₁₀, preferably C₁₋₄, alkylene group, Re and Rf are the same or different and each represents hydrogen, a hydroxyl group, an isocyanate group, an amino group, a carboxylic acid group, a C₁₋₂₀ alkyl group, or an aryl group, and n represents a natural number of 10 to 60, preferably 15 to 45.

Specific examples of the polyalkylene oxide include methylene oxide, ethylene oxide, propylene oxide, butylene oxide, cyclohexene oxide, styrene oxide, and the like; preferred among which are propylene oxide and butylene oxide each with a terminal hydroxyl group; and more preferred is butylene oxide with a terminal hydroxyl group.

Monomer Other than Host Group-Containing Polymerizable Monomer and Guest Molecule

The host group-containing polymerizable monomer of the present invention and the guest molecule can be combined with another polymerizable monomer to perform a polymerization reaction. A polymer is formed by this polymerization reaction, and a macromolecular material described later can be obtained. Below, polymerizable monomers including the host group-containing polymerizable monomer and another polymerizable monomer are referred to as “the polymerizable monomer mixture.”

Examples of the other polymerizable monomer include polymerizable monomers that are other than the host group-containing polymerizable monomer and the guest molecule, and that can be polymerized with the host group-containing polymerizable monomer and the guest molecule (hereinafter referred to as “the third polymerizable monomer”).

### Third Polymerizable Monomer

Among various compounds that can be polymerized with the host group-containing polymerizable monomer, examples of the third polymerizable monomer include compounds other than those used as the guest molecule. Examples of the third polymerizable monomer include various known polymerizable monomers.

Examples of the third polymerizable monomer include monomers that can be polymerized with the host group-containing polymerizable monomer. More specific examples include monomers that can form a urethane bond with the host group-containing polymerizable monomer.

Specific examples of the third polymerizable monomer include compounds having two or more amino groups, compounds having two or more hydroxyl groups, compounds having two or more carboxy groups, compounds having two or more epoxy groups, and compounds having two or more isocyanate groups, from the standpoint that a movable crosslinked polymer described later can be formed. These can be used singly or in combination of two or more.

Examples of compounds having two or more amino groups include 4,4′-diaminodiphenylmethane, 3,3′-diaminodiphenyl ether, 4,4′-diaminodiphenyl ether, 3,4′-diaminodiphenyl ether, 3,3′-diamninodiphenylmethane, 3,4′-diamninodiphenylmethane, o-phenylenediamine, m-phenylenediamine, p-phenylenediamine, 1,2-diaminoethane, 1,3-diaminopropane, 1,4-diaminobutane, 1,5-diaminopentane, 1,6-diaminohexane, 1,7-diaminoheptane, 1,8-diaminooctane, and the like. These can be used singly or in combination of two or more.

Examples of compounds having two or more hydroxyl groups include 4,4′-dihydroxydiphenylmethane, 1,3-propanediol, 1,3-butanediol, 2,3-butanediol, 1,4-butanediol, ethylene glycol, diethylene glycol, triethylene glycol, tetraethylene glycol, propylene glycol, dipropylene glycol, trimethylene glycol, bisphenol A, and the like. These can be used singly or in combination of two or more.

Examples of compounds having two or more carboxy groups include adipic acid, malonic acid, succinic acid, glutaric acid, and the like. These can be used singly or in combination of two or more.

Examples of compounds having two or more epoxy groups include polyalkylene glycol diglycidyl ethers, such as polyethylene glycol diglycidyl ether and poly-1-methylethylene glycol diglycidyl ether. The number average molecular weight Mn of the polyalkylene glycol diglycidyl ether can be 100 to 100000. These can be used singly or in combination of two or more.

Examples of compounds having two or more isocyanate groups include 4,4′-diphenylmethane diisocyanate (MDI), 1,6-hexamethylene diisocyanate (HDI), 2,4-tolylenediisocyanate (TDI), and the like. These can be used singly or in combination of two or more.

In addition, examples of condensable monomers include carbonyl chloride, diphenyl carbonate, and the like.

### 3. Macromolecular Material

The macromolecular material of the present invention may contain a polymer of the host group-containing polymerizable monomer. It is also preferable that the macromolecular material of the present invention contains a polymer of a polymerizable monomer mixture containing the host group-containing polymerizable monomer. More specifically, the macromolecular material preferably contains a polymer obtained by a polymerization reaction of the host group-containing polymerizable monomer. The polymer contained in the macromolecular material has a host group derived from the host group-containing polymerizable monomer. These polymers are also referred to as “macromolecular compounds.”

In the macromolecular material, a guest molecule penetrates the host group, and the guest molecule can be bonded by a hydrogen bond or the like to the polymer chain of the macromolecular material.

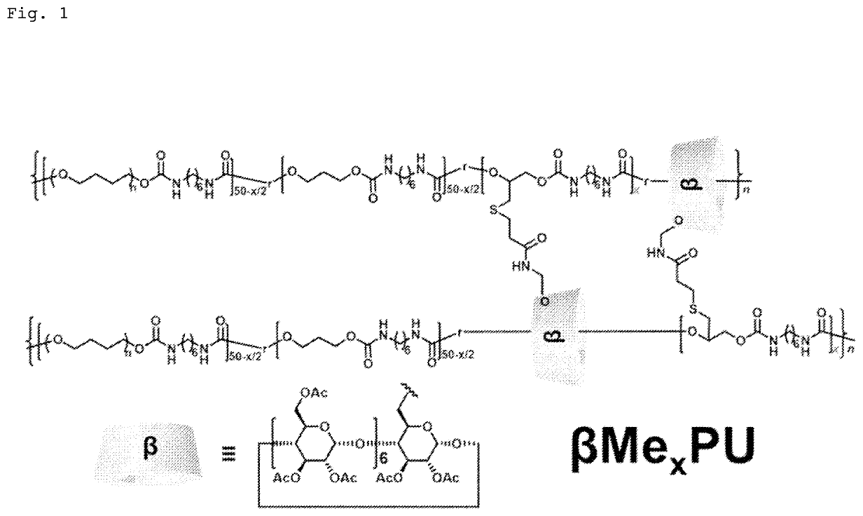

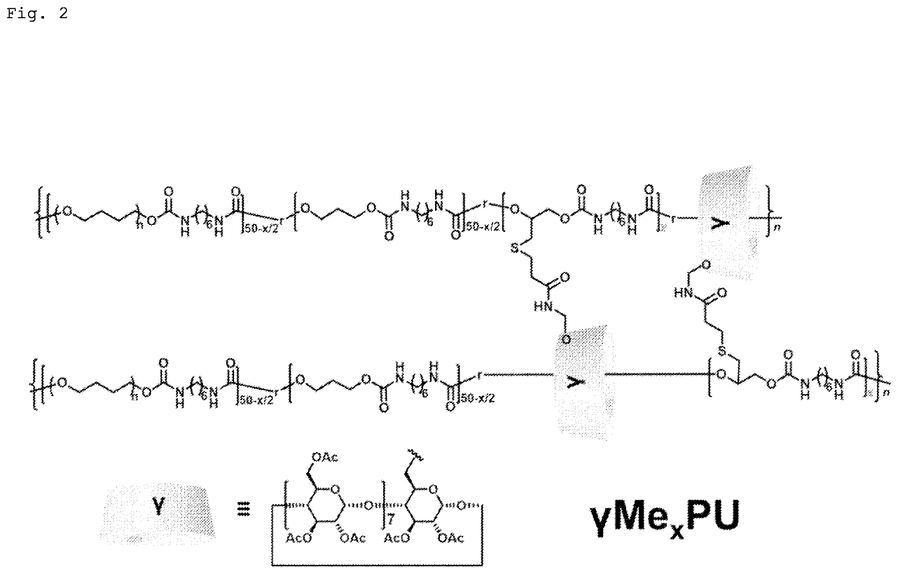

FIGS. 1 and 2 each schematically show an example of the macromolecular material of the present invention. FIG. 1 shows a macromolecular material in which the host group is a monovalent group formed by removing one hydrogen atom or hydroxy group from a β-cyclodextrin derivative, and FIG. 2 shows a macromolecular material in which the host group is a monovalent group formed by removing one hydrogen atom or hydroxy group from a γ-cyclodextrin derivative. FIGS. 1 and 2 show macromolecular materials using the host group-containing polymerizable monomer represented by the above formula (h1) as the host group-containing polymerizable monomer that forms each macromolecular material. In FIG. 1, the host group that is a monovalent group formed by removing one hydrogen atom or hydroxy group from a β-cyclodextrin derivative is indicated with the notation “3,” and such a macromolecular material is referred to, for example, as “βMeₓPU.” Further, in FIG. 2, the host group that is a monovalent group formed by removing one hydrogen atom or hydroxy group from a γ-cyclodextrin derivative is indicated with the notation “γ,” and such a macromolecular material is referred to, for example, as “γMeₓPU.” Below, the same notation including “Me” may also be used for FIGS. 3 to 19 and related descriptions.

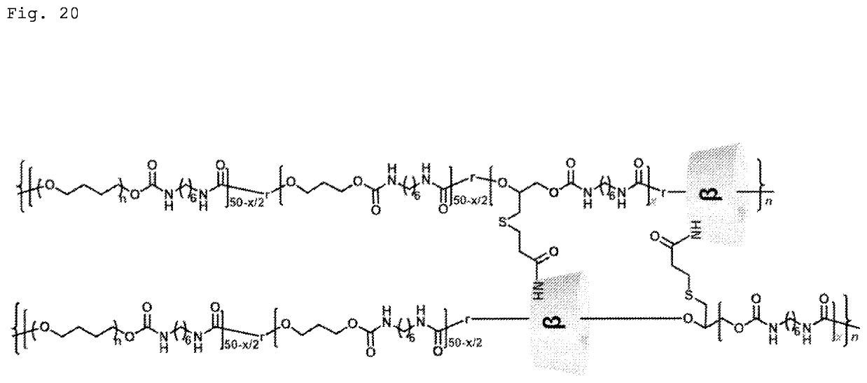

FIG. 20 schematically shows an example of the macromolecular material of the present invention. FIG. 20 shows a macromolecular material in which the host group is a monovalent group formed by removing one hydrogen atom or hydroxy group from a β-cyclodextrin derivative. FIG. 20 shows a macromolecular material using a host group-containing polymerizable monomer represented by the above formula (h2) as the host group-containing polymerizable monomer that forms the macromolecular material. In FIG. 20, the host group that is a monovalent group formed by removing one hydrogen atom or hydroxy group from a β-cyclodextrin derivative is indicated with the notation “β,” and such a macromolecular material is referred to, for example, as “βₓPU.” Below, the same notation may also be used for FIGS. 21 to 24 and related descriptions. In FIG. 20, the specific chemical formula of β is the same as the chemical formula of β in FIG. 1.

In the macromolecular materials shown in FIGS. 1, 2, and 20, a guest molecule penetrates the host group, and the hydrogen and oxygen atoms in the guest molecule and the oxygen and hydrogen atoms in the polymer of the host group-containing polymerizable monomer form a hydrogen bond, and side-chain movable crosslinking is formed by binding within the macromolecular material by so-called side-chain reversible bonding. FIGS. 1, 2, and 20 show macromolecular materials in which the guest molecule is another polymer obtained by using the host group-containing polymerizable monomer, and the main chain of the other polymer penetrates the host group; that is, these figures show the movable crosslinked structures described later.

In the macromolecular material of the present invention, even if shear force etc. is applied by cutting the macromolecular material, and the hydrogen bond between the guest molecule in the polymer chain and the polymer of the host group-containing polymerizable monomer is broken, the guest molecule moves movably while penetrating the host group, and the cut surfaces are reattached to form again a hydrogen bond between the guest molecule in the polymer chain and the polymer of the host group-containing polymerizable monomer. This allows the cut surfaces to rejoin and the macromolecular material to be healed. Therefore, the macromolecular material of the present invention can exhibit excellent self-healing properties.

As shown in FIGS. 1, 2, and 20, the macromolecular material of the present invention may have a movable crosslinked structure in which the guest molecule is another polymer obtained by using the host group-containing polymerizable monomer, and the main chain of the other polymer penetrates the host group. A crosslinked structure is formed such that the main chain of another polymer penetrates the host group of the polymer, and the polymer chain of the other polymer penetrating the ring of the host group can slide. That is, the macromolecular material of the present invention can form a so-called crosslinked structure having mobility (movable crosslinked structure). This crosslinked structure may also be referred to as a single cross network. Due to this crosslinked structure, the macromolecular material of the present invention has improved mechanical properties (particularly both Young's modulus and fracture energy), and can have excellent flexibility while being strong. The other polymer that penetrates the host group also has a host group, which can act as a so-called stopper to prevent removal.

Whether the macromolecular material forms a movable crosslinked structure can be determined, for example, from the swelling test results of the macromolecular material. For example, a macromolecular material is prepared without using a chemical crosslinking agent, and the resulting macromolecular material is added to a solvent. In that case, if the macromolecular material is swollen without being dissolved, it can be determined that a movable crosslinked structure is formed, whereas if the macromolecular material is dissolved, it can be determined that a movable crosslinked structure is not formed.

The macromolecular material of the present invention may also have a single cross penetrating (SCP) structure. This is described below. FIG. 30 is a conceptual diagram showing a production method to produce a macromolecular material having a SCP structure from the above movable crosslinked structure.

As shown in FIG. 30, the macromolecular material of the present invention may further contain a chain macromolecular compound in which a main chain monomer is polymerized. In FIG. 30, the chain macromolecular compound penetrates the mesh of a movable crosslinked structure. The mesh of a movable crosslinked structure as mentioned herein refers to the mesh of a movable crosslinked structure formed such that the main chain of another macromolecular compound penetrates the host group of the macromolecular compound.

In the macromolecular material of the present invention, the presence of a chain macromolecular compound penetrating the mesh of a movable crosslinked structure more easily improves the mechanical properties of the macromolecular material of the present invention.

The chain macromolecular compound is a macromolecular compound that does not have a host group, and examples include polymers obtained by polymerization of various polymerizable monomers. Examples of polymerizable monomers include (meth)acrylic acid, allylamine, maleic anhydride, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, hexyl (meth)acrylate, cyclohexyl (meth)acrylate, n-octyl (meth)acrylate, (meth)acrylamide, N,N-dimethyl (meth)acrylamide, N,N-diethyl acrylamide, N-isopropyl (meth)acrylamide, N-hydroxymethyl (meth)acrylamide, hydroxymethyl (meth)acrylate, 2-hydroxyethyl (meth)acrylamide, 2-hydroxyethyl (meth)acrylate, ethoxy-diethylene glycol (meth)acrylate, methoxy-triethylene glycol (meth)acrylate, methoxy-polyethylene glycol (meth)acrylate, styrene, and the like.

The chain macromolecular compound is preferably (meth)acrylic acid, (meth)acrylic ester, (meth)acrylamide, or a derivative polymer thereof, and more preferably a polymer, such as methyl (meth)acrylate, ethyl (meth)acrylate, n-propyl (meth)acrylate, or isopropyl (meth)acrylate, because it is likely to exist while penetrating the mesh of the movable crosslinked structure described above.

The mass average molecular weight (Mw) of the chain macromolecular compound is not particularly limited, and can be, for example, 10,000 to 2 million, and preferably 20,000 to 1 million. The chain macromolecular compound can have, for example, a structure of a homopolymer, a random polymer, or the like. Further, the chain macromolecular compound can be linear, and can also have a branched structure or a crosslinked structure as long as the effects of the present invention are not impaired.

In the macromolecular material having a SCP structure of the present invention, the content ratio of the macromolecular compound and the chain macromolecular compound is not particularly limited. For example, because the mechanical properties are likely to increase, the content ratio of the macromolecular compound to the total mass of the macromolecular compound and the chain macromolecular compound can be, for example, 10 mass % or more, preferably 20 mass % or more, more preferably 40 mass % or more, and even more preferably 50 mass % or more. Because the mechanical properties are likely to increase, the content ratio of the macromolecular compound to the total mass of the macromolecular compound and the chain macromolecular compound can be 90 mass % or less, preferably 80 mass % or less, and more preferably 70 mass % or less.

The macromolecular material having a SCP structure of the present invention may contain additives other than the macromolecular compound and the chain macromolecular compound, or may be formed only from the macromolecular compound and the chain macromolecular compound.

The method for producing the macromolecular material having a SCP structure of the present invention is not particularly limited. For example, known methods can be widely used. For example, in the process of mixing a solution of a macromolecular compound dissolved in a solvent and drying the solvent, the main chain of another macromolecular compound may penetrate at least one host group of the macromolecular compound. As a result, a crosslinked structure (the movable crosslinked structure described above) is formed, and the macromolecular material of the present invention is obtained.

Further, a polymerization reaction for obtaining a chain macromolecular compound is performed in the presence of the macromolecular compound with a movable crosslinked structure formed therein, whereby a macromolecular material in which the chain macromolecular compound penetrates the mesh of the crosslinked structure (having a SCP structure) can be produced. Specifically, a polymerization reaction of the polymerizable monomer for obtaining a chain macromolecular compound is performed in the presence of a macromolecular compound by a known polymerization method, such as solvent-free polymerization, thereby obtaining a macromolecular material. In this production method, the macromolecular compound has a movable crosslinked structure; thus, the polymerizable monomer tends to cause swelling of the macromolecular compound, and as a result, the main chain of the polymerizable monomer is likely to penetrate the mesh of the movable crosslinked structure.

### 4. Method for Producing Macromolecular Material

The method for producing the macromolecular material is not particularly limited. Examples of the method for producing the macromolecular material include a production method comprising subjecting a polymerizable monomer mixture containing the host group-containing polymerizable monomer of the present invention to a polymerization reaction to obtain a polymer. Such a production method is also included in the present invention.

As the polymerizable monomer mixture containing the host group-containing polymerizable monomer used in the above step, the polymerizable monomer mixture described in the above section “Monomer other than Host Group-Containing Polymerizable Monomer and Guest Molecule” can be used.

The polymerization reaction of the polymerizable monomer mixture containing the host group-containing can be performed by a known method. As such a method, for example, the host group-containing polymerizable monomer of the present invention, a guest molecule, and another polymerizable monomer that constitutes the polymerizable monomer mixture, such as a third polymerizable monomer, are dissolved in a solvent, mixed, and polymerized.

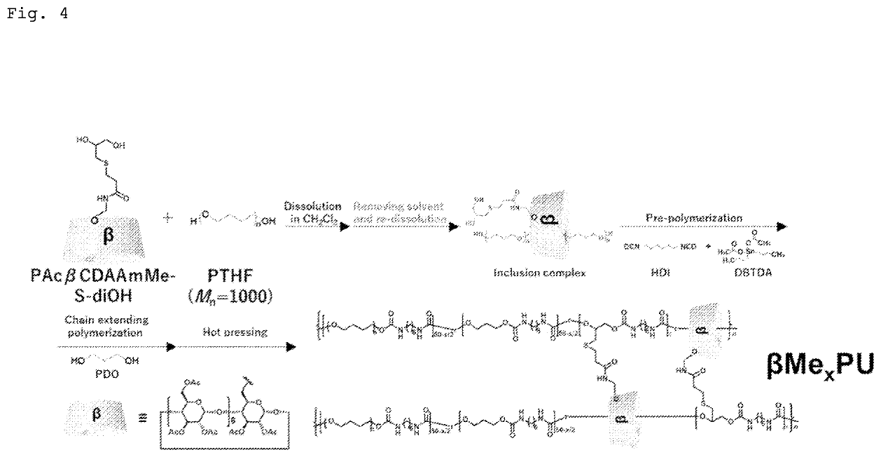

Specific examples of the method for producing the macromolecular material of the present invention include the production methods shown in FIGS. 4, 7, and 22. The production methods shown in FIGS. 4, 7, and 22 have step 1 of dissolving the host group-containing polymerizable monomer of the present invention and a guest molecule in a solvent and mixing them to prepare an inclusion compound, step 2 of adding another polymerizable monomer to the solvent containing the inclusion compound to prepare a polymerizable monomer mixture and performing pre-polymerization to obtain a pre-polymerized polymer, and step 3 of adding another polymerizable monomer to the solvent containing the pre-polymerized polymer to react them, thereby performing molecular chain extending polymerization. This production method is described below.

### Step 1

Step 1 is to dissolve and mix the host group-containing polymerizable monomer of the present invention and a guest molecule in a solvent to prepare an inclusion compound. As the host group-containing polymerizable monomer and the guest molecule, those described above can be used.

As for the mixing ratio of the host group-containing polymerizable monomer and the guest molecule, the amount of the guest molecule is preferably 0.8 to 1.2 mol, and more preferably 0.9 to 1.1 mol, per mol of the host group-containing polymerizable monomer. Because the molar ratio of the guest molecule per mol of the host group-containing polymerizable monomer is within the above range, the host group-containing polymerizable monomer and the guest molecule can be reacted, neither overreacting nor underreacting.

The solvent is not particularly limited as long as it can dissolve the host group-containing polymerizable monomer and the guest molecule. Examples include dichloromethane, N,N-dimethylformamide, dimethyl sulfoxide, and the like. Among these, dichloromethane is preferred in terms of more excellent solubility.

The heating temperature, i.e., the temperature of the solvent, in step 1 is not particularly limited, and is, for example, 20 to 100° C., and preferably 50 to 80° C. Further, the heating time is 1 minute to 12 hours, and preferably 15 minutes to 1 hour. The heating means is also not particularly limited, and examples include a method using a hot stirrer, a method using a constant-temperature bath, and the like.

Whether an inclusion compound is formed can be determined, for example, by visually observing the condition of the inclusion compound. Specifically, when an inclusion compound is not formed, it is in a suspended state or in a phase-separated state when allowed to stand, whereas when an inclusion compound is formed, it can be in a viscous gel-like or cream-like state. When an inclusion compound is formed, it can be transparent.

In step 1, after an inclusion compound is prepared in a solvent, the solvent may be removed once, and the inclusion compound may be dissolved again in a solvent. Impurities contained in the solvent can be removed by dissolving the inclusion compound again in a solvent.

Through step 1 explained above, an inclusion compound in which a guest molecule penetrates the host group of the host group-containing polymerizable monomer can be obtained. The inclusion compound is formed such that host-guest interaction occurs between the host group and the guest molecule. When such an inclusion compound is formed, the inclusion compound is dissolved in a solvent to form a more homogeneous solution; thus, the polymerization reaction progresses easily, host-guest interaction is easily formed in the resulting polymer, and as a result, the toughness and strength of the resulting macromolecular material are likely to be improved.

### Step 2

Step 2 is to add another polymerizable monomer to the solvent containing the inclusion compound to prepare a polymerizable monomer mixture, and perform pre-polymerization to obtain a pre-polymerized polymer. As the other polymerizable monomer, the third polymerizable monomer described above can be used.

The polymerization reaction in pre-polymerization is not particularly limited as long as the inclusion compound can be polymerized. Polymerization methods such as urethane polymerization and urea polymerization can be used, and preferred among these is urethane polymerization.

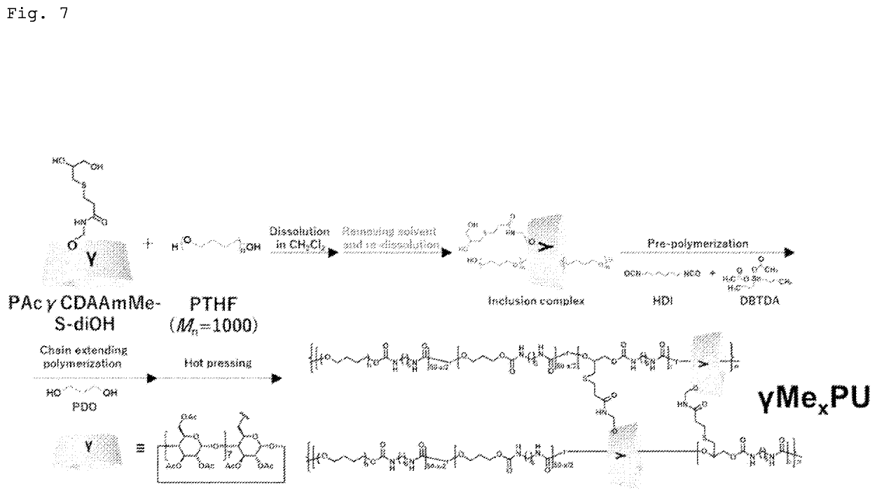

In the production methods shown in FIGS. 4 and 7, a polymerization reaction is performed by urethane polymerization. When the inclusion compound is subjected to a polymerization reaction by urethane polymerization, as the other polymerizable monomer, a compound that forms a urethane bond together with the inclusion compound may be polymerized in the presence of a catalyst.

Examples of the compound that forms a urethane bond together with the inclusion compound include compounds having a group that can form a urethane bond together with Rb and Rc in the above formula (h1) or (h2). Examples of such groups include a hydroxyl group and an isocyanate group.

Among the third polymerizable monomers described above, a compound having a group that can form a urethane bond together with Rb and Rc in the above formula (h1) or (h2) can be used as the compound that forms a urethane bond together with the inclusion compound. Specific examples include hexamethylene diisocyanate, isophorone diisocyanate, and the like. Preferred among these is hexamethylene diisocyanate, because the reaction rate is faster and the product has a stronger hydrogen bond.

The mixing ratio of the inclusion compound and the compound that forms a urethane bond together with the inclusion compound is such that the amount of the compound that forms a urethane bond together with the inclusion compound is preferably 0.5 to 2.0 mol, and more preferably 1.0 to 1.1 mol, per mol of the inclusion compound. Because the number of moles of the compound that forms a urethane bond together with the inclusion compound per mol of the inclusion compound is within the above range, the amount of host group in the polymer contained in the macromolecular material can be adjusted to an appropriate amount, and the toughness and strength of the macromolecular material can be further improved.

The catalyst is not particularly limited, and a known catalyst used for urethane polymerization can be used. Examples of such catalysts include dibutyltin diacetate (DBTDA), dibutyltin dilaurate (DBTDL), and the like. Preferred among these is dibutyltin diacetate (DBTDA), which can exhibit relatively low toxicity and an appropriate reaction rate.

The amount of the catalyst is not particularly limited, and is preferably 0.01 to 0.2 parts by mass, and more preferably 0.08 to 0.12 parts by mass, based on the total amount of the inclusion compound and the other polymerizable monomer, which is taken as 100 parts by mass.

The temperature of the polymerization reaction in pre-polymerization is not particularly limited, and the polymerization reaction can be performed under appropriate conditions, for example, at 0 to 100° C., and preferably 20 to 25° C.

The time of the polymerization reaction in pre-polymerization is not particularly limited, and can be 1 minute to 24 hours, and preferably 1 hour to 24 hours.

As shown in FIGS. 4 and 7, in the polymerization reaction, the main chain of the polymer chain of the inclusion compound and the other polymerizable monomer may contain a guest molecule. As for such a guest molecule, a guest molecule added in the preparation of the inclusion compound remains in the reaction system, and the remaining guest molecule can be incorporated in the polymerization reaction.

Through step 2 explained above, a pre-polymerized polymer can be obtained.

### Step 3

Step 3 is to add another polymerizable monomer to the solvent containing the pre-polymerized polymer and react them to perform molecular chain extending polymerization.

As the other polymerizable monomer in step 3, the third polymerizable monomer described above can be used. The same polymerizable monomer as used in step 2 may be used, or a different one may be used. As the other polymerizable monomer in step 3, it is preferable to use a polymerizable monomer that can be polymerized with the other polymerizable monomer used in step 2. Due to the use of such a polymerizable monomer, the other polymerizable monomer used in step 2 and the other polymerizable monomer used in step 3 can be polymerized to extend the molecular chain of the polymer contained in the macromolecular material, and the molecular weight of the polymer chain of the polymer, and the amounts of urethane bond and host group can be adjusted to appropriate amounts.

The polymerization reaction in molecular chain extending reaction is not particularly limited as long as the molecular chain of the pre-polymerized polymer obtained in step 3 can be extended. Polymerization methods such as urethane polymerization and urea polymerization can be used, and preferred among these is urethane polymerization.

In the production methods shown in FIGS. 4, 7, and 22, the polymerization reaction is performed by urethane polymerization. When the polymerization reaction is performed by urethane polymerization, a compound that forms a urethane bond together with the other polymerizable monomer used in step 2 may be used as the polymerizable monomer.

Examples of the compound that forms a urethane bond together with the other polymerizable monomer used in step 2 include compounds having a group that can form a urethane bond together with the other polymerizable monomer used in step 2. Examples of such groups include a hydroxyl group and an isocyanate group.

Among the third polymerizable monomers described above, a compound having a group that can form a urethane bond together with the other polymerizable monomer used in step 2 can be used as the compound that forms a urethane bond together with the other polymerizable monomer used in step 2. Specific examples include propanediol, 1,4-butanediol, and the like. Preferred among these is propanediol, which is cheaper and more responsive.

The amount of the other polymerizable monomer used in step 3 is preferably 0.5 to 2 mol, and more preferably 0.08 to 1.2 mol, per mol of the other polymerizable monomer used in step 2. Because the molar ratio of the other polymerizable monomer used in step 3 per mol of the other polymerizable monomer used in step 2 is within the above range, the other polymerizable monomer used in step 2 and the other polymerizable monomer used in step 3 can be reacted, neither overreacting nor underreacting, and the molecular chain of the pre-polymerized polymer can be sufficiently extended.

The temperature of the polymerization reaction in molecular chain extending polymerization is not particularly limited, and the polymerization reaction can be performed under appropriate conditions, for example, at 0 to 100° C., and preferably 20 to 25° C.

The time of the polymerization reaction in molecular chain extending polymerization is not particularly limited, and can be 1 minute to 24 hours, and preferably 1 hour to 24 hours.

Through step 3 explained above, molecular chain extending polymerization is performed, whereby the macromolecular material of the present invention can be produced.

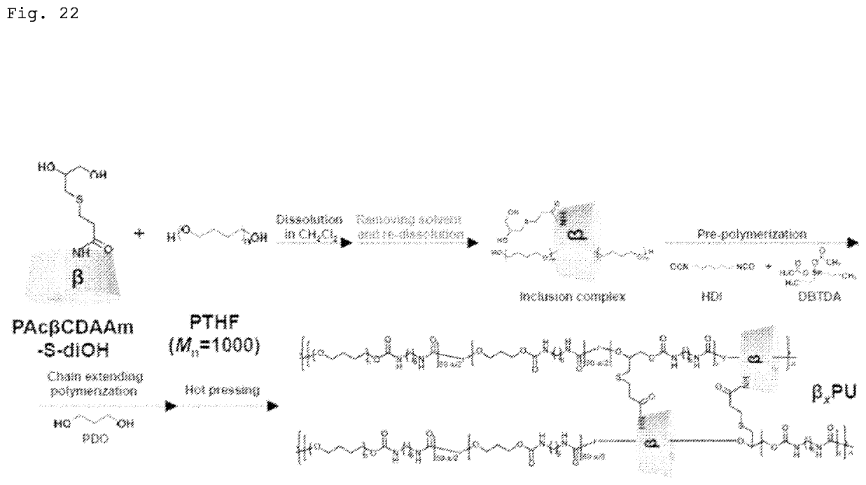

Polymer βMeₓPU as the final product in FIG. 4, polymer γMeₓPU as the final product in FIG. 7, and polymer βₓPU as the final product in FIG. 22 contain a host group-containing unit obtained by polymerization of the host group-containing polymerizable monomer of the present invention and the other polymerizable monomer used in step 2. In the polymer βMeₓPU as the final product in FIG. 4, the polymer γMeₓPU as the final product in FIG. 7, and the polymer βₓPU as the final product in FIG. 22, x in each chemical formula represents the content (mol %) of the host group-containing unit based on the total of structural units constituting each polymer, which is taken as 100 mol %. For example, βMe₅PU represents that the content of the host group-containing unit is 5 mol % based on the total of structural units constituting the polymer, which is taken as 100 mol %.

The content x (mol %) of the host group-containing unit is preferably 1 to 50 mol %, more preferably 3 to 30 mol %, and even more preferably 5 to 20 mol %. Because the content of the host group-containing unit is within the above range, the fracture energy of the macromolecular material is further improved.

The shape of the macromolecular material is not particularly limited. For example, the macromolecular material can be in any of various forms, such as membranes, films, sheets, particles, plates, blocks, pellets, and powders.

The macromolecular material has excellent toughness and strength, and can be produced by a simple process. Therefore, the macromolecular material can be used for various applications. For example, the macromolecular material can be suitably used for various components for automotive applications, electronic component applications, construction material applications, food container applications, transportation container applications, and the like.

### EXAMPLES

Below, the present invention is described in more detail with reference to Examples. However, the present invention is not limited to the embodiments of the Examples.

### Production Example 1: Production of Host Group-Containing Polymerizable Monomer (PAcβCDAAmMe-S-diOH)

PAcβCDAAmMe-S-diOH was produced according to the scheme shown in FIG. 3. Specifically, PAcβCDAAmMe (2.1 g, 1 mmol), α-thioglycerol (1.1 g, 10 mmol), and IRGACURE 184 (20 mg, 0.1 mmol) were added to 5 mL of methanol and dissolved to prepare a mixed solution. While stirring the prepared mixed solution for 1 hour, the mixed solution was irradiated with UV light. Then, the mixed solution was added dropwise to water (1 L) and filtered by suction to separate a white precipitate solid. The obtained precipitate solid was dried in vacuum at 80° C. for 16 hours to produce solid PAcβCDAAmMe-S-diOH.

### Examples 1-1 to 1-5: Macromolecular Material (Production of βMeₓPU)

βMeₓPU was produced according to the scheme shown in FIG. 4. In the scheme, -r- represents a so-called random copolymer in which repeating structural units are randomly arranged, and the same applies hereafter. In Example 1-1 (x=5 mol %), Example 1-2 (x=9 mol %), Example 1-3 (x=13 mol %), Example 1-4 (x=17 mol %), and Example 1-5 (x=20 mol %), the amount of each raw material added was set as shown in Table 1 below to adjust the value of x.

TABLE 1

| | | PAcβCDAAmMe-S-diOH/g | PTHF/g | HDI/g | PDO/g | DBTDA/mg |
|---|---|---|---|---|---|---|
| Example 1-1 | βMe₅PU | 0.217 | 1.000 | 0.353 | 0.076 | 1.6 |
| Example 1-2 | βMe₉PU | 0.433 | 1.000 | 0.370 | 0.076 | 1.8 |
| Example 1-3 | βMe₁₃PU | 0.650 | 1.000 | 0.387 | 0.076 | 2.0 |
| Example 1-4 | βMe₁₇PU | 0.866 | 1.000 | 0.404 | 0.076 | 2.3 |
| Example 1-5 | βMe₂₀PU | 1.083 | 1.000 | 0.421 | 0.076 | 2.5 |

Specifically, first, polytetrahydrofuran (PTHF, Mn=1,000) and 1,3-propanediol (PDO) were each heated at 90° C. under vacuum for 2 hours to remove moisture. Then, the dried PAcβCDAAmMe-S-diOH powder was added to a dichloromethane (5.0 mL) solution of PTHF to prepare a mixture, and the mixture was stirred and dissolved at room temperature under a N₂ atmosphere to prepare a mixed solution. Dichloromethane was removed from the mixed solution with a N₂ gas flow, thereby obtaining a white powder of a PAcβCDAAmMe-S-diOHPTHF complex. Then, after completely removing the solvent, dichloromethane (10 mL) was added to redissolve the complex. Then, a mixture of hexamethylene diisocyanate (HDI) and dibutyltin diacetate (DBTDA) was added to the solution and stirred to prepare a homogeneous solution. The solution was then stirred at room temperature under a N₂ atmosphere for 2 hours to perform polymerization (pre-polymerization).

A solution of 1,3-propanediol (PDO) dissolved in dichloromethane (1.0 mL) was added to the solution prepared by pre-polymerization and polymerized by stirring at room temperature for 24 hours to prepare a reaction solution (polymerization). Because the reaction solution was not homogeneous, dichloromethane was additionally added to the reaction solution. After polymerization, the reaction solution was poured into a Teflon mold (product name, size: 50 mm×50 mm×1.0 mm) and heated at 60° C. to remove the solvent. Then, vacuum drying was performed at 40° C. for 16 hours to produce sheet-like βMeₓPU containing air bubbles. Finally, to remove the air bubbles, βMeₓPU was pressed in a hot press in vacuum at 2 kN at 110° C. for 2 minutes at a vacuum degree of <80 Pa to produce a transparent βMeₓPU sheet-like test piece.

### Comparative Example 1: Macromolecular Material (Production of PU)

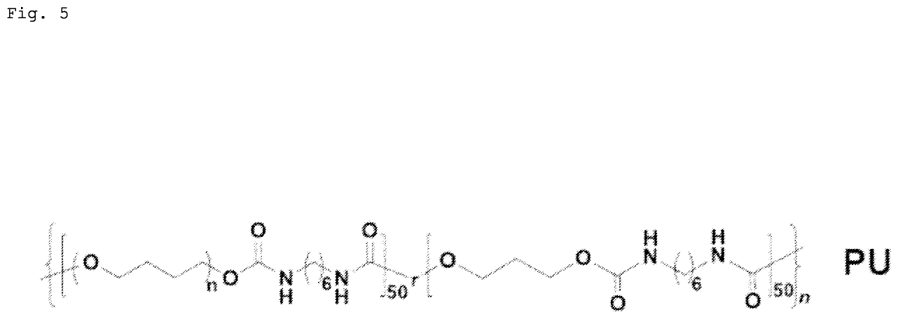

In the same manner as in Examples 1-1 to 1-5, a test piece of polyurethane resin (PU) was produced according to the scheme shown in FIG. 4. However, in Comparative Example 1, PAcβCDAAmMe-S-diOH and PAcγCDAAmMe-S-diOH were not used, and the amount of each raw material added was set as shown in Table 2 below, thereby preparing PU shown in FIG. 5. That is, the macromolecular material (PU) prepared in Comparative Example 1 does not have a host group.

TABLE 2

| | | PAcβCDAAmMe-S- | | | | |
|---|---|---|---|---|---|---|
| | | diOH/g | | | | |
| | | PAcγCDAAmMe-S- | | | | |
| | | diOH/g | PTHF/g | HDI/g | PDO/g | DBTDA/mg |
| Comparative | PU | — | 1.000 | 0.336 | 0.076 | 1.4 |
| Example 1 | | | | | | |

### Production Example 2: Production of Host Group-Containing Polymerizable Monomer (PAcγCDAAmMe-S-diOH)

PAcγCDAAmMe-S-diOH was produced according to the scheme shown in FIG. 6. Specifically, PAcγCDAAmMe (2.3 g, 1 mmol), α-thioglycerol (1.1 g, 10 mmol), and IRGACURE 184 (20 mg, 0.1 mmol) were added to 5 mL of methanol and dissolved to prepare a mixed solution. While stirring the prepared mixed solution for 1 hour, the mixed solution was irradiated with UV light. Then, the mixed solution was added dropwise to water (1 L) and filtered by suction to separate a white precipitate solid. The obtained precipitate solid was dried in vacuum at 80° C. for 16 hours to produce solid PAcγCDAAmMe-S-diOH.

### Examples 2-1 to 2-5: Macromolecular Material (Production of γMeₓPU)

A test piece of γMeₓPU was produced according to the scheme shown in FIG. 7. In Example 2-1 (x=5 mol %), Example 2-2 (x=9 mol %), Example 2-3 (x=13 mol %), Example 2-4 (x=17 mol %), and Example 2-5 (x=20 mol %), the amount of each raw material added was set as shown in Table 3 below to adjust the value of x.

TABLE 3

| | | PAcγCDAAmMe-S-diOH/g | PTHF/g | HDI/g | PDO/g | DBTDA/mg |
|---|---|---|---|---|---|---|
| Example 2-1 | γMe5PU | 0.246 | 1.000 | 0.353 | 0.076 | 1.7 |
| Example 2-2 | γMe9PU | 0.491 | 1.000 | 0.370 | 0.076 | 1.9 |
| Example 2-3 | γMe13PU | 0.738 | 1.000 | 0.387 | 0.076 | 2.2 |
| Example 2-4 | γMe17PU | 0.984 | 1.000 | 0.404 | 0.076 | 2.4 |
| Example 2-5 | γMe20PU | 1.230 | 1.000 | 0.421 | 0.076 | 2.7 |

Specifically, first, polytetrahydrofuran (PTHF, Mn=1,000) and 1,3-propanediol (PDO) were each heated at 90° C. under vacuum for 2 hours to remove moisture. Then, the dried PAcγCDAAmMe-S-diOH powder was added to a dichloromethane (5.0 mL) solution of PTHF to prepare a mixture, and the mixture was stirred and dissolved at room temperature under a N₂ atmosphere to prepare a mixed solution. Dichloromethane was removed from the mixed solution with a N₂ gas flow, thereby obtaining a white powder of a PAcγCDAAmMe-S-diOHPTHF complex. Then, after completely removing the solvent, dichloromethane (10 mL) was added to redissolve the complex. Then, a mixture of hexamethylene diisocyanate (HDI) and dibutyltin diacetate (DBTDA) was added to the solution and stirred to prepare a homogeneous solution. The solution was then stirred at room temperature under a N₂ atmosphere for 2 hours to perform polymerization (pre-polymerization).

A solution of 1,3-propanediol (PDO) dissolved in dichloromethane (1.0 mL) was added to the solution prepared by pre-polymerization and polymerized by stirring at room temperature for 24 hours to prepare a reaction solution (polymerization). Because the reaction solution was not homogeneous, dichloromethane was additionally added to the reaction solution. After polymerization, the reaction solution was poured into a Teflon mold (product name, size: 50 mm×50 mm×1.0 mm) and heated at 60° C. to remove the solvent. Then, vacuum drying was performed at 40° C. for 16 hours to produce sheet-like γMeₓPU containing air bubbles. Finally, to remove the air bubbles, γMeₓPU was pressed in a hot press in vacuum at 2 kN at 110° C. for 2 minutes at a vacuum degree of <80 Pa to produce a transparent γMeₓPU sheet-like test piece.

### Evaluation Method of Mechanical Properties

The mechanical properties of the macromolecular materials formed from the polymers obtained in the Examples and Comparative Examples were evaluated by a tensile test. The tensile test was performed using a stroke-load curve test (Autograph AGX-plus, produced by Shimadzu Corporation) at room temperature at a tensile speed of 10 mm/min (uniaxial elongation until rupture; stress changes were recorded) to observe the rupture point of each sample (thickness: 100 to 300 μm). With this rupture point taken as the final point, the maximum stress applied until the final point was determined to be the rupture stress of the sample. This tensile test was performed with the bottom end of the macromolecular material fixed, and the upper end pulled at a tension rate of 10 mm/min (upward operation). Further, a value obtained by dividing the stroke at that time, that is, the maximum length when the test piece was pulled, by the length of the test piece before pulling was calculated as the elongation rate (which may also be referred to as the strain rate). Further, the fracture energy (MJ/m³) of each macromolecular material was calculated from the area of the obtained stress-strain curve.

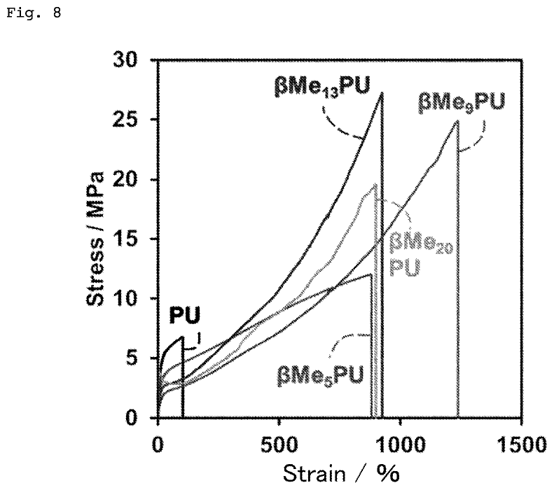

FIG. 8 shows the stress-strain curves of Example 1-1 to Example 1-3, Example 1-5, and Comparative Example 1.

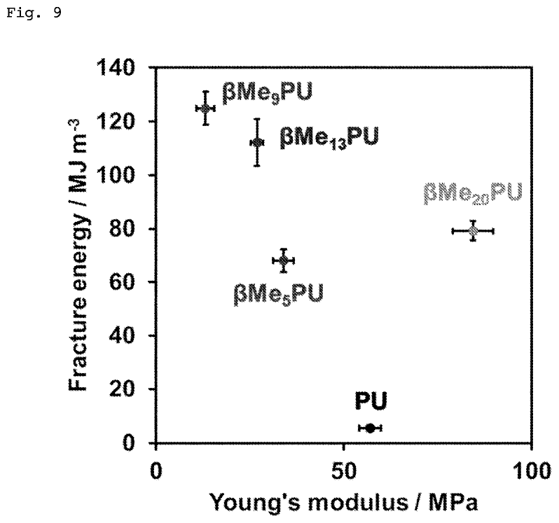

FIG. 9 shows the relationship between Young's modulus and fracture energy in Example 1-1 to Example 1-3, Example 1-5, and Comparative Example 1.

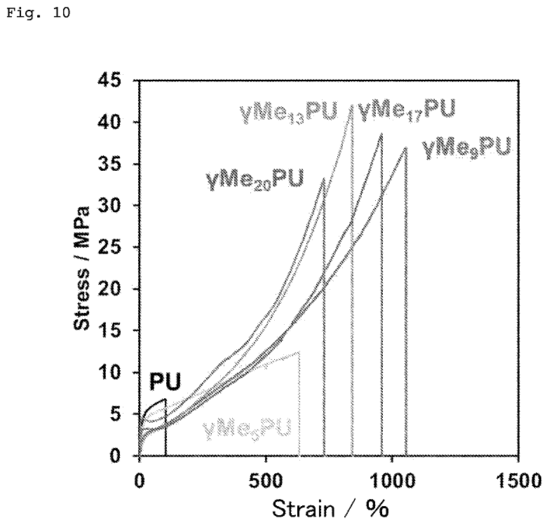

FIG. 10 shows the stress-strain curves of Example 2-1 to Example 2-5 and Comparative Example 1.

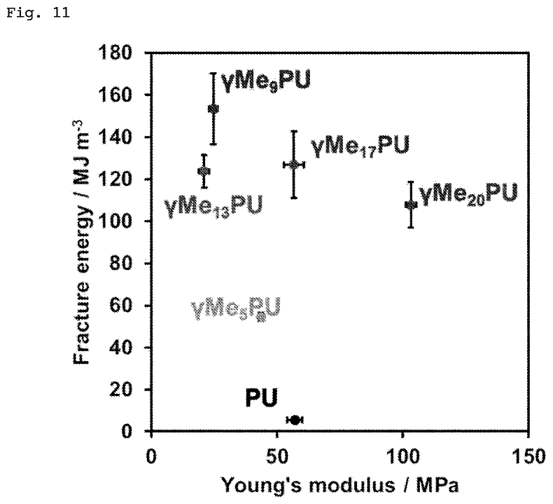

FIG. 11 shows the relationship between Young's modulus and fracture energy in Example 2-1 to Example 2-5 and Comparative Example 1.

The results of FIGS. 8 to 11 indicated that the macromolecular materials formed from the polymers obtained in the Examples had superior mechanical properties to the polyurethane resin of Comparative Example 1. The reason for this is presumed to be that these macromolecular materials have host-guest interaction within the molecules.

### Stress Relaxation Test

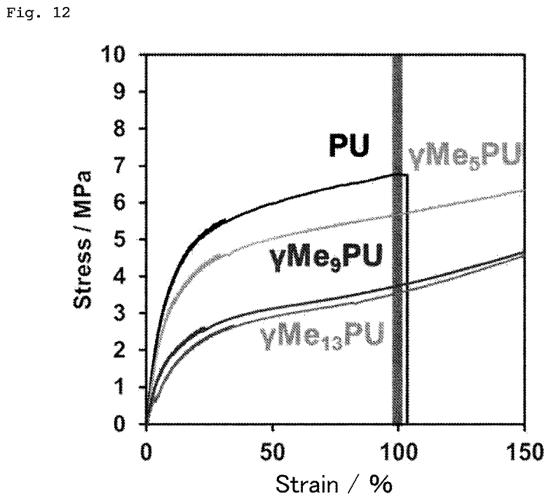

A stress relaxation test was performed using the macromolecular materials formed from the polymers obtained in Example 2-1 to Example 2-3 and Comparative Example 1. Specifically, a tensile test was performed to determine the strain in the stress relaxation test according to the test method and conditions described above in the evaluation method of mechanical properties, the strain at which the macromolecular materials formed from the polymers obtained in Example 2-1 to Example 2-3 and Comparative Example 1 did not break was measured, and the strain in the stress relaxation test was set to 100%. FIG. 12 shows the results of the tensile test for determining the strain in the stress relaxation test.

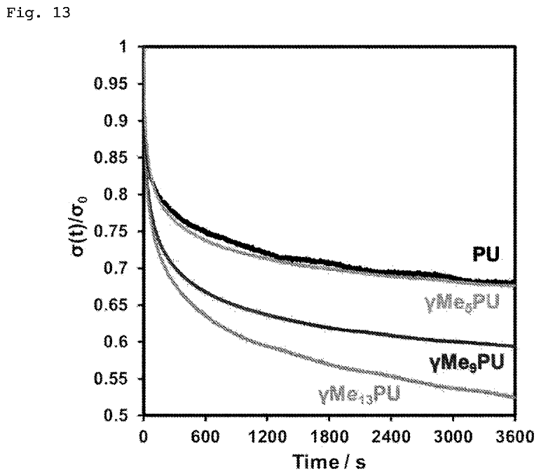

Then, the strain was fixed at 100%, and changes in stress were measured over time. The changes in stress were measured by calculating δ(t)/δ0, where δ0 is the stress when the strain is fixed at 100%, and δ(t) is the stress after t seconds. FIG. 13 shows the measurement results of the stress relaxation test.

The results of FIG. 12 indicated that the macromolecular materials formed from the polymers obtained in Example 2-1 to Example 2-3 had less stress at the same strain than the polyurethane resin of Comparative Example 1 and did not break even at a strain exceeding 100%. Because the polyurethane resin of Comparative Example 1 broke at a strain exceeding 100%, the strain in the stress relaxation test was set to 100%. The results of FIG. 13 indicated that in the macromolecular materials formed from the polymers obtained in Example 2-1 to Example 2-3, the rate of stress relaxation was faster than that of the polyurethane resin of Comparative Example 1. The reason for this is presumed to be that these macromolecular materials have host-guest interaction between the guest molecule and cyclodextrin.

### Evaluation of Self-Healing Properties

Self-healing properties were evaluated using the macromolecular materials formed from the polymers obtained in Example 2-1 to Example 2-3 and Comparative Example 1. Specifically, a scratch (cross-sectional area of scratch: 500 to 3000 μm²) was made on the surface of each of the macromolecular materials formed from the polymers obtained in Example 2-1 to Example 2-3 and Comparative Example 1 (thickness: 0.5 mm) with a razor, followed by heating at 60° C. for 5 minutes for healing. Before and after healing, the condition of each macromolecular material was measured by the following method, and the self-healing properties were evaluated.

Photographing with Microscope and Laser Microscope

The appearance of the surface of each of the macromolecular materials formed from the polymers obtained in Example 2-1 to Example 2-3 and Comparative Example 1 was photographed using a microscope at 10× magnification immediately after scratching (before healing) and after being allowed to stand at 60° C. for 5 minutes (after healing). In addition, scar profiles were measured by a multi-file analysis application by observing the cross section of each macromolecular material using a laser microscope immediately after scratching (before healing) and after being allowed to stand at 60° C. for 5 minutes (after healing).

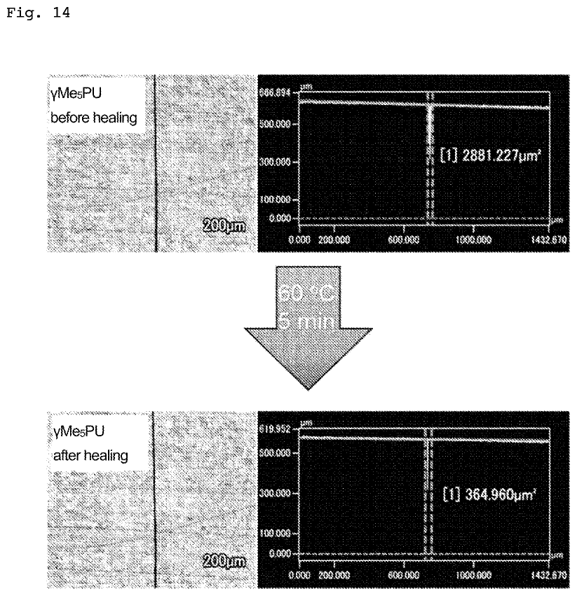

FIG. 14 shows the results of the macromolecular material formed from the polymer obtained in Example 2-1 photographed with a microscope and a laser microscope.

FIG. 15 shows the results of the macromolecular material formed from the polymer obtained in Example 2-2 photographed with a microscope and a laser microscope.

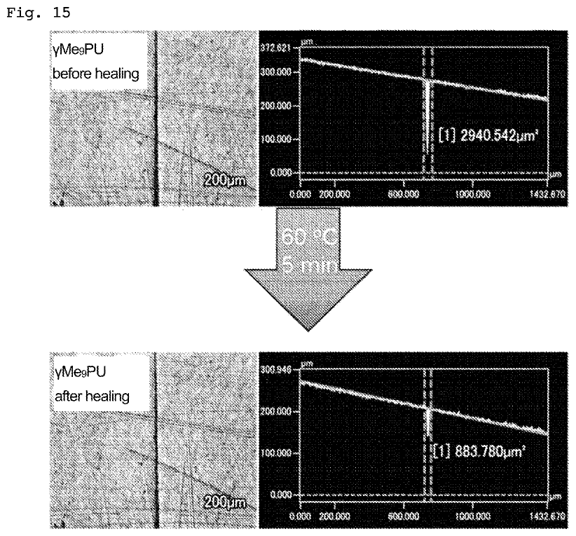

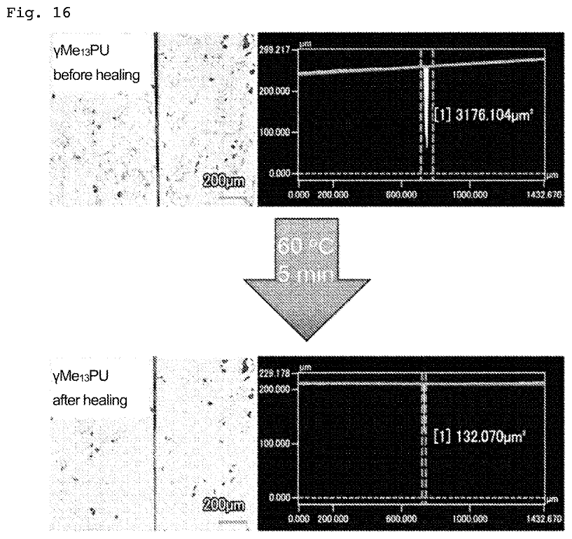

FIG. 16 shows the results of the macromolecular material formed from the polymer obtained in Example 2-3 photographed with a microscope and a laser microscope.

FIG. 17 shows the results of the macromolecular material formed from the polymer obtained in Comparative Example 1 photographed with a microscope and a laser microscope.

### Evaluation of Scratch Area

The area of the scratch before and after healing in each of the macromolecular materials formed from the polymers obtained in Example 2-1 to Example 2-3 and Comparative Example 1 was measured from cross-sectional images of the scratch drawn using a laser microscope.

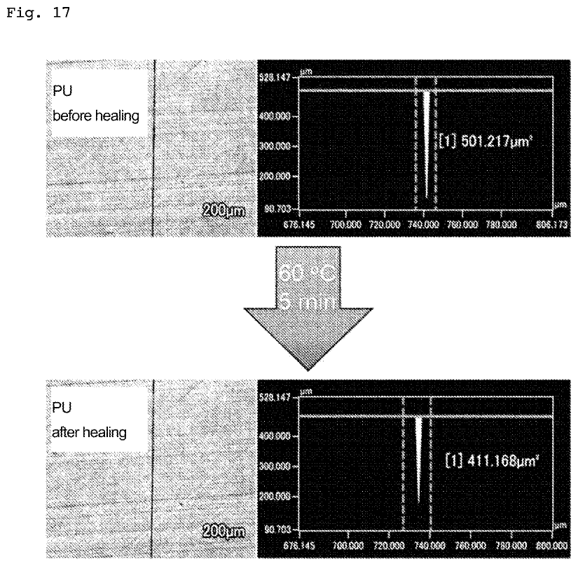

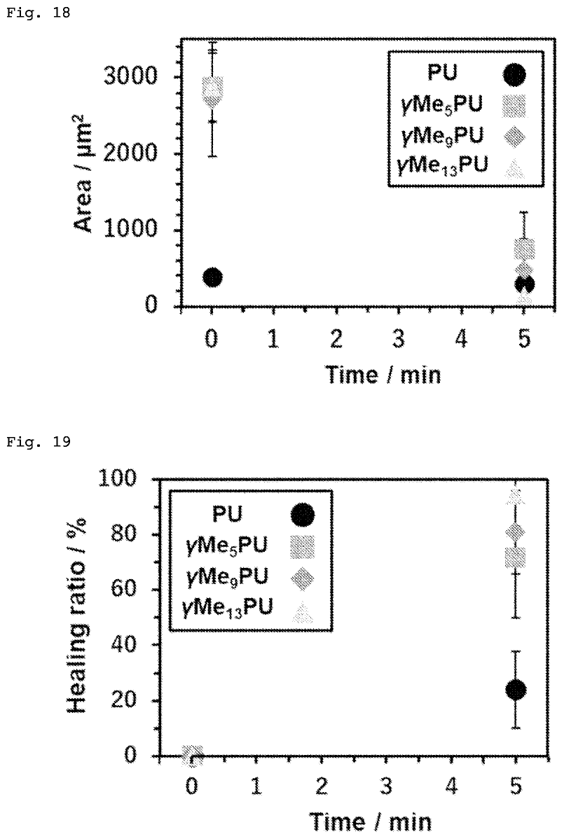

FIG. 18 shows the relationship between scratch area and time in the macromolecular materials formed from the polymers obtained in Example 2-1 to Example 2-3 and Comparative Example 1.

### Measurement of Scratch Healing Ratio

The scratch healing ratio of each of the macromolecular materials formed from the polymers obtained in Example 2-1 to Example 2-3 and Comparative Example 1 was calculated using the following formula:

$$Scratch healing ratio ( \% ) = \{ 1 - [ ( area of scratch after being allowed to stand at a predetermined temperature for a predetermined time ) / ( area of scratch immediately after scratching ) ] \} \times 100$$

FIG. 19 shows the relationship between scratch healing ratio and time in the macromolecular materials formed from the polymers obtained in Example 2-1 to Example 2-3 and Comparative Example 1.

The results of FIGS. 14 to 17 indicated that the depth of the scratch in the macromolecular materials formed from the polymers obtained in Example 2-1 to Example 2-3 was shallower over time than in the polyurethane resin of Comparative Example 1.

The results of FIG. 18 indicated that despite the larger initial (time=0 min) scratch area, the scratch area in the macromolecular materials formed from the polymers obtained in Example 2-1 to Example 2-3 became smaller over time than in the polyurethane resin of Comparative Example 1. The initial scratch area of the polyurethane resin of Comparative Example 1 could not be the same as the area of the macromolecular materials formed from the polymers obtained in Example 2-1 to Example 2-3 because it broke in the case of the same area.

The results of FIG. 19 indicated that the scratch healing ratio in the macromolecular materials formed from the polymers obtained in Example 2-1 to Example 2-3 was higher over time than in the polyurethane resin of Comparative Example 1.

The results of FIGS. 14 to 19 described above revealed that the macromolecular materials formed from the polymers obtained in Example 2-1 to Example 2-3 had excellent self-healing properties. The reason for this is presumed to be that these macromolecular materials have host-guest interaction between the guest molecule and cyclodextrin.

### Production Example 3: Production of Host Group-Containing Polymerizable Monomer (PAcβCDAAm-S-diOH)

PAcβCDAAm-S-diOH was produced according to the scheme shown in FIG. 21. Specifically, PAcβCDAAm (2.0 g, 1 mmol), α-thioglycerol (1.1 g, 10 mmol), and IRGACURE 184 (20 mg, 0.1 mmol) were added to 5 mL of methanol and dissolved to prepare a mixed solution. While stirring the prepared mixed solution for 1 hour, the mixed solution was irradiated with UV light. Then, the mixed solution was added dropwise to water (1 L) and filtered by suction to separate a white precipitate solid. The obtained precipitate solid was dried in vacuum at 80° C. for 16 hours to produce solid PAcβCDAAm-S-diOH.

### Example 3-1: Macromolecular Material (Production of βₓPU)

βₓPU was produced according to the scheme shown in FIG. 22. In the scheme, -r- represents a so-called random copolymer in which repeating structural units are randomly arranged, and the same applies hereafter. In Example 3-1 (x=5 mol %), the amount of each raw material added was set as shown in Table 4 below to adjust the value of x.

TABLE 4

| | | PAcβCDAAm-S-diOH/g | PTHF/g | HDI/g | PDO/g | DBTDA/mg |
|---|---|---|---|---|---|---|
| Example 3-1 | β₅PU | 0.214 | 1.000 | 0.353 | 0.076 | 1.6 |

Specifically, first, polytetrahydrofuran (PTHF, Mn=1,000) and 1,3-propanediol (PDO) were each heated at 90° C. under vacuum for 2 hours to remove moisture. Then, the dried PAcβCDAAm-S-diOH powder was added to a dichloromethane (5.0 mL) solution of PTHF to prepare a mixture, and the mixture was stirred and dissolved at room temperature under a N₂ atmosphere to prepare a mixed solution. Dichloromethane was removed from the mixed solution with a N₂ gas flow, thereby obtaining a white powder of a PAcβCDAAm-S-diOHPTHF complex. Then, after completely removing the solvent, dichloromethane (10 mL) was added to redissolve the complex. Then, a mixture of hexamethylene diisocyanate (HDI) and dibutyltin diacetate (DBTDA) was added to the solution and stirred to prepare a homogeneous solution. The solution was then stirred at room temperature under a N₂ atmosphere for 2 hours to perform polymerization (pre-polymerization).

A solution of 1,3-propanediol (PDO) dissolved in dichloromethane (1.0 mL) was added to the solution prepared by pre-polymerization and polymerized by stirring at room temperature for 24 hours to prepare a reaction solution (polymerization). Because the reaction solution was not homogeneous, dichloromethane was additionally added to the reaction solution. After polymerization, the reaction solution was poured into a Teflon mold (product name, size: 50 mm×50 mm×1.0 mm) and heated at 60° C. to remove the solvent. Then, vacuum drying was performed at 40° C. for 16 hours to produce sheet-like βₓPU containing air bubbles. Finally, to remove the air bubbles, βₓPU was pressed in a hot press in vacuum at 2 kN at 110° C. for 2 minutes at a vacuum degree of <80 Pa to produce a transparent βₓPU sheet-like test piece.

### Evaluation of Mechanical Properties

The mechanical properties of the macromolecular materials formed from the polymers obtained in Example 3-1 and Comparative Example 1 were evaluated by a tensile test in the same manner as the evaluation method of mechanical properties described above.

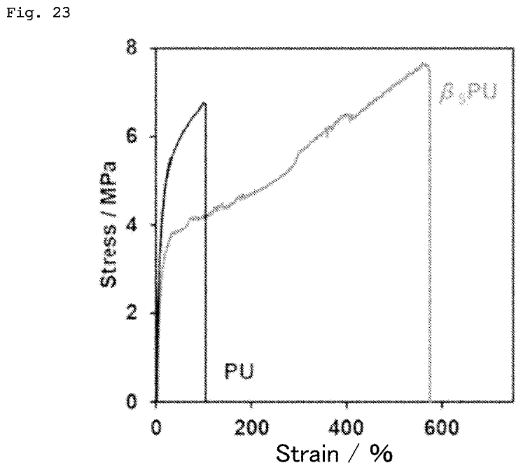

FIG. 23 shows the stress-strain curves of Example 3-1 and Comparative Example 1.

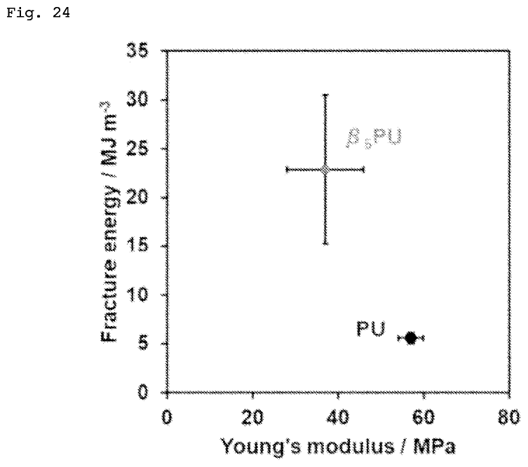

FIG. 24 shows the relationship between Young's modulus and fracture energy in Example 3-1 and Comparative Example 1.

The results of FIGS. 23 and 24 indicated that the macromolecular material formed from the polymer obtained in Example 3-1 had superior mechanical properties to the polyurethane resin of Comparative Example 1. The reason for this is presumed to be that these macromolecular materials have host-guest interaction within the molecules.

### Production of SCP-Crosslinking Macromolecular Material Example 4-1

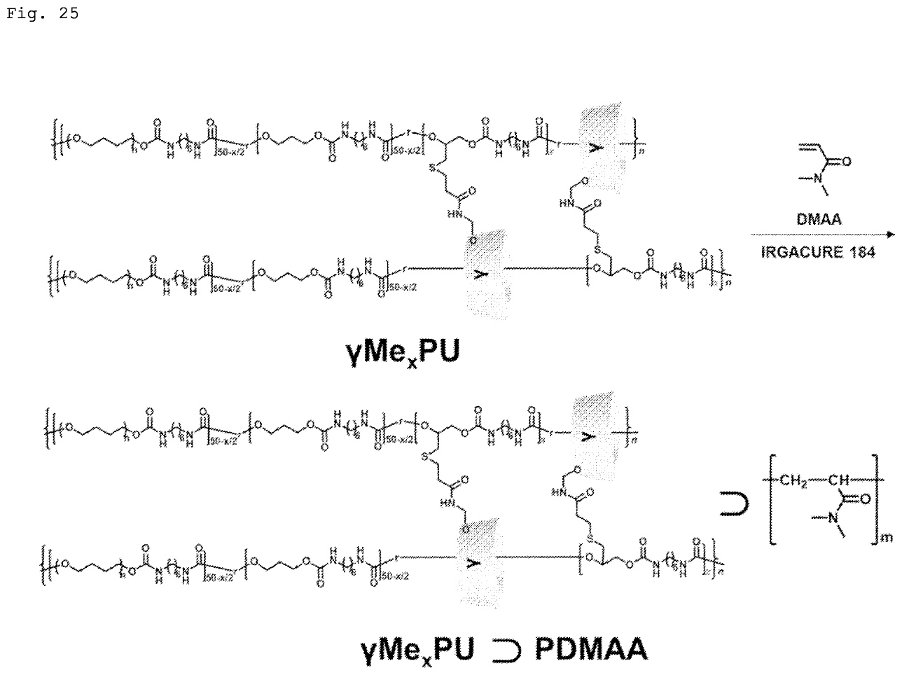

A SCP-crosslinking material (γMeₓPU⊃PDMAA) of γMe₅PU produced in Example 2-1 and polydimethylacrylamide (PDMAA) was produced according to the scheme shown in FIG. 25. Specifically, γMe₅PU and DMAA were mixed according to the formulation shown in Table 5 below, and sonication was performed until they were completely dissolved. Then, IRGACURE 184 was added as a photopolymerization initiator, and the resulting mixture was poured into a mold. Then, the resultant was irradiated with light using a mercury lamp for 1 hour to perform photopolymerization, thereby obtaining a solid. The obtained solid was dried overnight using a vacuum oven at 80° C. to produce a SCP-crosslinking material (γMeₓPU⊃PDMAA).

### Example 4-2

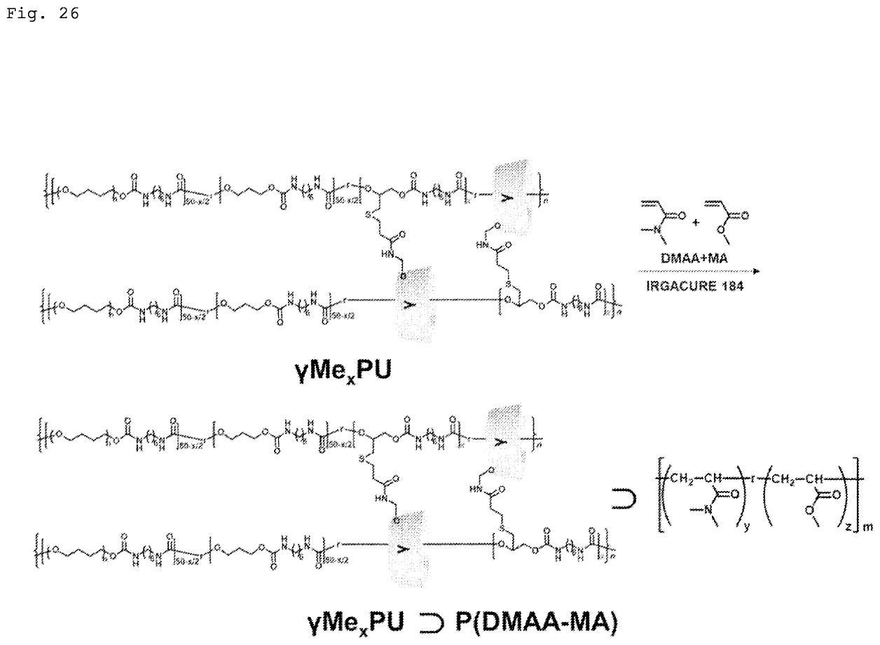

A SCP-crosslinking material (γMeₓPU⊃P (DMAA-MA)) of γMe₅PU produced in Example 2-1 and a copolymer P (DMAA-MA) of dimethyl acrylamide (DMAA) and methacrylic acid (MA) was produced according to the scheme shown in FIG. 26. Specifically, γMe₅PU, DMAA, and MA were mixed according to the formulation shown in Table 5 below, and sonication was performed until they were completely dissolved. Then, IRGACURE 184 was added as a photopolymerization initiator, and the resulting mixture was poured into a mold. Then, the resultant was irradiated with light using a mercury lamp for 1 hour to perform photopolymerization, thereby obtaining a solid. The obtained solid was dried overnight using a vacuum oven at 80° C. to produce a SCP-crosslinking material (γMeₓPU⊃P (DMAA-MA)).

### Production of Macromolecular Mixed Material

### Comparative Example 4-1

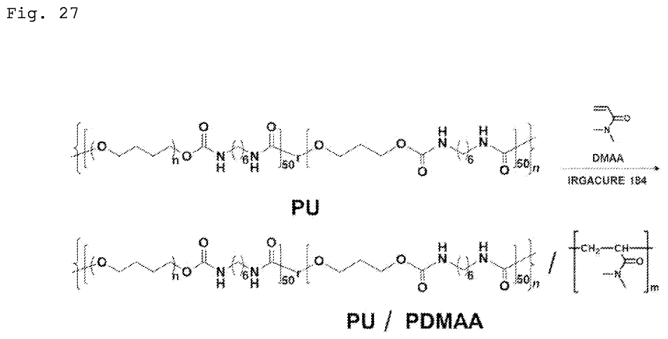

A macromolecular mixed material (PU⊃PDMAA) of PU produced in Comparative Example 1 and dimethyl acrylamide (DMAA) was produced according to the scheme shown in FIG. 27. Specifically, PU and DMAA were mixed according to the formulation shown in Table 5 below, and sonication was performed until they were completely dissolved. Then, IRGACURE 184 was added as a photopolymerization initiator, and the resulting mixture was poured into a mold. Then, the resultant was irradiated with light using a mercury lamp for 1 hour to perform photopolymerization, thereby obtaining a solid. The obtained solid was dried overnight using a vacuum oven at 80° C. to produce a macromolecular mixed material (PU/PDMAA).

TABLE 5

| | | PU or | | | |
|---|---|---|---|---|---|
| | | γMe₅PU | DMAA | MA | IRGACURE |
| | | (mg) | (mg) | (mg) | 184 (mg) |
| Example | γMe₅PU⊃PDMAA | 100 | 900 | — | 4 |
| 4-1 | | | | | |
| Example | γMe₅PU⊃P | 100 | 450 | 450 | 4 |
| 4-2 | (DMAA-MA) | | | | |
| Compar- | PU/PDMAA | 100 | 900 | — | 4 |
| ative | | | | | |
| Example | | | | | |
| 4-1 | | | | | |

### Evaluation of Mechanical Properties

The mechanical properties of the SCP-crosslinking macromolecular material produced in Example 4-2 and the macromolecular mixed material produced in Comparative Example 4-1 were evaluated by a tensile test in the same manner as the evaluation method of mechanical properties described above.

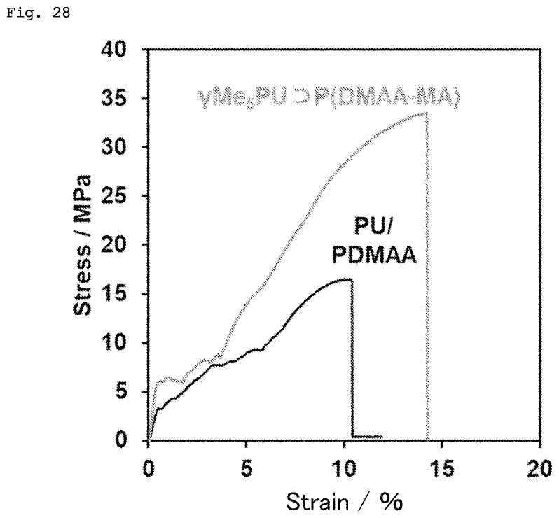

FIG. 28 shows the stress-strain curves of Example 4-2 and Comparative Example 4-1.

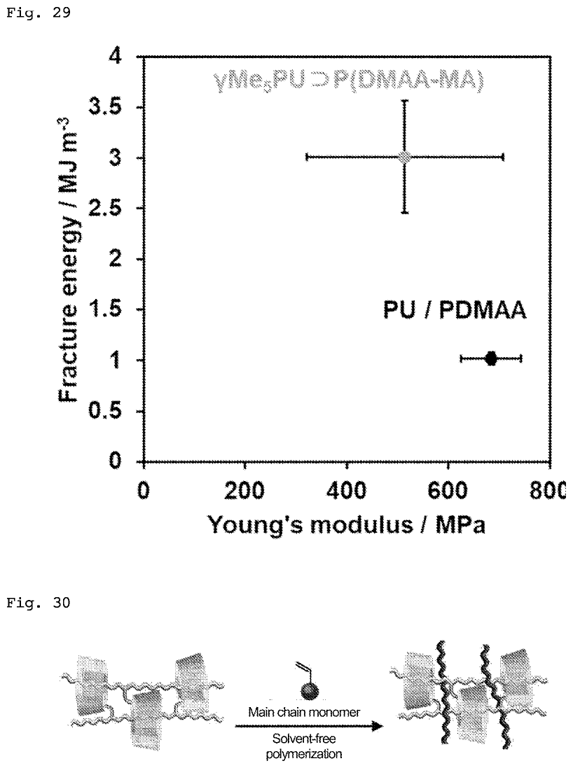

FIG. 29 shows the relationship between Young's modulus and fracture energy in Example 4-2 and Comparative Example 4-1.

The results of FIGS. 28 and 29 indicated that the SCP-crosslinking macromolecular material obtained in Example 4-2 had superior mechanical properties to the macromolecular mixed material obtained in Comparative Example 4-1.

1. A host group-containing polymerizable monomer,
the host group-containing polymerizable monomer having a sulfide group,
the host group being a monovalent group formed by removing one hydrogen atom or hydroxy group from a cyclodextrin derivative, and
the cyclodextrin derivative having a structure formed such that a hydrogen atom of at least one hydroxy group contained in a cyclodextrin is replaced with at least one group selected from the group consisting of a hydrocarbon group, an acyl group, and —CONHR wherein R represents a methyl group or an ethyl group.

2. The host group-containing polymerizable monomer according to claim 1, wherein the acyl group is an acetyl group.

3. The host group-containing polymerizable monomer according to claim 1, wherein the hydrocarbon group has 1 to 4 carbon atoms.

4. The host group-containing polymerizable monomer according to claim 1, which is represented by the following formula (h1): 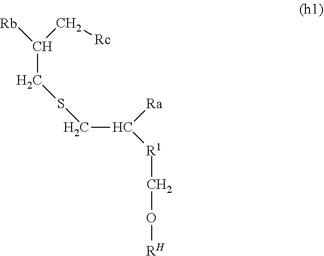
wherein in formula (h1), Ra represents a hydrogen atom or a methyl group, Rb and Rc represents a hydroxyl group or an isocyanate group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group.

5. The host group-containing polymerizable monomer according to claim 1, which is represented by the following formula (h2): 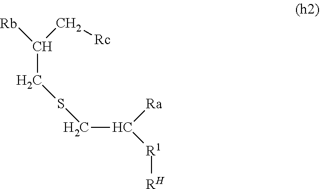
wherein in formula (h2), Ra represents a hydrogen atom or a methyl group, Rb and Rc represents a hydroxyl group or an isocyanate group, R^{H} represents the host group, and R¹ represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxyl group.

6. A method for producing a host group-containing polymerizable monomer, comprising reacting a host group-containing polymerizable monomer and a thiol group-containing compound having a thiol group and two functional groups.

7. The method according to claim 6, wherein the reaction is a thiol-ene reaction.

8. A macromolecular material comprising a polymer of the host group-containing polymerizable monomer according to claim 1.

9. A method for producing a macromolecular material, comprising subjecting a polymerizable monomer mixture containing the host group-containing polymerizable monomer according to claim 1 to a polymerization reaction to obtain a polymer.

10. A macromolecular material comprising a polymer of the host group-containing polymerizable monomer according to claim 2.

11. A macromolecular material comprising a polymer of the host group-containing polymerizable monomer according to claim 3.

12. A macromolecular material comprising a polymer of the host group-containing polymerizable monomer according to claim 4.

13. A macromolecular material comprising a polymer of the host group-containing polymerizable monomer according to claim 5.

14. A method for producing a macromolecular material, comprising subjecting a polymerizable monomer mixture containing the host group-containing polymerizable monomer according to claim 2 to a polymerization reaction to obtain a polymer.

15. A method for producing a macromolecular material, comprising subjecting a polymerizable monomer mixture containing the host group-containing polymerizable monomer according to claim 3 to a polymerization reaction to obtain a polymer.

16. A method for producing a macromolecular material, comprising subjecting a polymerizable monomer mixture containing the host group-containing polymerizable monomer according to claim 4 to a polymerization reaction to obtain a polymer.

17. A method for producing a macromolecular material, comprising subjecting a polymerizable monomer mixture containing the host group-containing polymerizable monomer according to claim 5 to a polymerization reaction to obtain a polymer.
